(19) United States
(12) Patent Application Publication
(10) Pub. No.: US 2005/0285828 A1
(43) Pub. Date: Dec. 29, 2005

(54) Signal processing circuit and method for self-luminous type display

(75) Inventors: Masutaka Inoue, Osaka (JP); Haruhiko Murata, Osaka (JP); Yukio Mori, Osaka (JP); Atsuhiro Yamashita, Osaka (JP); Susumu Tanase, Osaka (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/165,272

(22) Filed: Jun. 24, 2005

(30) Foreign Application Priority Data
Jun. 25, 2004 (JP) 2004-188392
Oct. 5, 2004 (JP) 2004-292968
Dec. 8, 2004 (JP) 2004-355693
Dec. 8, 2004 (JP) 2004-355694

(51) Int. Cl. G09G 3/30

(52) U.S. Cl. 345/76

(57) ABSTRACT

In a self-luminous type display in which one pixel includes four unit pixels of RGBW, a signal processing circuit includes first, second and third parts. The first part subtracts a minimum value in RGB input signals from each input signal of RGB. The second part calculates an RGBW signal corresponding to the case in which all the RGB input signals are the minimum value, based on an RGB signal value for realizing target white when all the RGB input signals are a maximum value. The third part determines the RGBW signal by adding a signal corresponding to each RGB subtraction result to the RGBW signal calculated by the second part. Each RGB subtraction result is calculated by the first part.

### BACKGROUND OF THE INVENTION

1. Field of the Invention

The invention relates to a signal processing circuit and signal processing method for a self-luminous type display.

2. Description of the Related Art

A self-luminous type display such as an organic EL display has advantages of slim thickness, light weight, low-electrical power consumption, and the like. The uses of self-luminous type display are widely being increased. However, in the uses of mobile phones, digital still camera, and the like, further low-electrical power consumption is required.

In the self-luminous type display such as the organic EL display in which a color filter is affixed to a self-luminous material, light usable efficiency becomes worse because light is partially absorbed in the color filter while the light passes through the color filter. The low light usable efficiency prevents the decrease in electrical power consumption.

### SUMMARY OF THE INVENTION

An object of the invention is to provide a signal processing circuit and a signal processing method for a self-luminous type display, in which one pixel includes four unit pixels of RGBW, the color filters are provided in the RGB unit pixels, and the color filter is not provided in the W unit pixel, the signal processing circuit and signal processing method capable of achieving the low-electrical power consumption.

Another object of the invention is to provide a signal processing circuit and a signal processing method for a self-luminous type display, in which one pixel includes four unit pixels of RGBX and X is an arbitrary color besides RGB, the signal processing circuit and signal processing method capable of converting an RGB signal into an RGBX signal.

Still another object of the invention is to provide a signal processing circuit and a signal processing method for a self-luminous type display, in which one pixel includes five unit pixels of RGBWX and X is an arbitrary color besides RGB, the signal processing circuit and signal processing method capable of converting an RGB signal into an RGBWX signal and improving the light usable efficiency.

According to the invention, there is provided a first signal processing circuit for a self-luminous type display in which one pixel includes four unit pixels of RGBW, the signal processing circuit including: first means for subtracting a minimum value in RGB input signals from each input signal of RGB; second means for calculating an RGBW signal corresponding to the case in which all the RGB input signals are the minimum value, based on an RGBW signal value for realizing target white when all the RGB input signals are a maximum value; and third means for determining the RGBW signal by adding a signal corresponding to each RGB subtraction result to the RGBW signal calculated by the second means, each RGB subtraction result being calculated by the first means.

According to the invention, there is provided a second signal processing circuit for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing circuit including: first means for subtracting a minimum value in RGB input signals from each input signal of RGB; second means for calculating an RGBW signal corresponding to the case in which all the RGB input signals are the minimum value based on an RGBW signal value for realizing target white when all the RGB input signals are a maximum value; and third means for determining the RGBW signal by adding a signal corresponding to each RGB subtraction result to the RGBW signal calculated by the second means, each RGB subtraction result being calculated by the first means.

According to the invention, there is provided a third signal processing circuit for a self-luminous type display, in which one pixel includes four unit pixels of RGBW, color filters are provided in the RGB unit pixels respectively, and the color filter is not provided in the W unit pixel, the signal processing circuit including: reverse gamma correction means for converting an RGB input signal into a pre-gamma correction RGB signal by performing reverse gamma correction to the RGB input signal, gamma correction being previously performed to the RGB input signal; RGB-RGBW signal conversion means for setting the RGB signal at the RGB input signal to convert the RGB input signal into an RGBW signal, the RGB signal being obtained by the reverse gamma correction means; and gamma correction means for performing the gamma correction to the RGBW signal according to the self-luminous type display, the RGBW signal being obtained by the RGB-RGBW signal conversion means, wherein an RGBW signal value for realizing target white is set when all the RGB signals obtained by the reverse gamma correction means are a maximum value, while white-side reference brightness of RGB is set such that the target white can be realized by only RGB when all the RGB signals obtained by the reverse gamma correction means are the same value, and the RGB-RGBW signal conversion means includes: first means for subtracting a minimum value in RGB input signals from each input signal of RGB; second means for calculating an RGBW signal corresponding to the case in which all the RGB input signals are the minimum value, based on an RGBW signal value for realizing target white when all the RGB input signals are a maximum value; and third means for determining the RGBW signal by adding a signal corresponding to each RGB subtraction result to the RGBW signal calculated by the second means, each RGB subtraction result being calculated by the first means.

According to the invention, there is provided a fourth signal processing circuit for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing circuit including: first means for subtracting a minimum value in RGB input signals from each input signal of RGB; second means for calculating an RGBW signal corresponding to the case in which all the RGB input signals are the minimum value, based on an RGBW signal value for realizing target white when all the RGB input signals are a maximum value; third means for determining the RGBW signal by adding a signal corresponding to each RGB subtraction result to the RGBW signal calculated by the second means, each RGB subtraction result being calculated by the first means; fourth means for calculating the RGBW signal in the same manner as for the first means, the second means and the third means by setting the RGBW signal at an intermediate RGBW signal to regard the RGB signal in the intermediate RGBW signal as the RGB input signal, the RGBW signal being obtained by the third means, the fourth means generating the RGBW signal by adding the W signal in the intermediate RGBW signal to the W signal of the calculated RGBW signal, when the minimum value in the RGB signal in the RGBW signal calculated by the third means is not zero; and fifth means for performing the same process as for the fourth means by setting the RGBW signal at the intermediate RGBW signal, the RGBW signal being obtained by the fourth means, when the minimum value in the RGB signal in the RGBW signal calculated by the fourth means is not zero.

According to the invention, there is provided a fifth signal processing circuit for a self-luminous type display, in which one pixel includes four unit pixels of RGBW, color filters are provided in the RGB unit pixels respectively, and the color filter is not provided in the W unit pixel, the signal processing circuit including: reverse gamma correction means for converting an RGB input signal into a pre-gamma correction RGB signal by performing reverse gamma correction to the RGB input signal, gamma correction being previously performed to the RGB input signal; RGB-RGBW signal conversion means for setting the RGB signal at the RGB input signal to convert the RGB input signal into an RGBW signal, the RGB signal being obtained by the reverse gamma correction means; and gamma correction means for performing the gamma correction to the RGBW signal according to the self-luminous type display, the RGBW signal being obtained by the RGB-RGBW signal conversion means, wherein an RGBW signal value for realizing target white is set when all the RGB input signals obtained by the reverse gamma correction means are a maximum value, while white-side reference brightness of RGB is set such that the target white can be realized by only RGB when all the RGB signals obtained by the reverse gamma correction means are the same value, and the RGB-RGBW signal conversion means includes: first means for subtracting a minimum value in RGB input signals from each input signal of RGB; second means for calculating an RGBW signal corresponding to the case in which all the RGB input signals are the minimum value, based on an RGBW signal value for realizing target white when all the RGB input signals are a maximum value; third means for determining the RGBW signal by adding a signal corresponding to each RGB subtraction result to the RGBW signal calculated by the second means, each RGB subtraction result being calculated by the first means; fourth means for calculating the RGBW signal in the same manner as for the first means, the second means and the third means by setting the RGBW signal at an intermediate RGBW signal to regard the RGB signal in the intermediate RGBW signal as the RGB input signal, the RGBW signal being obtained by the third means, the fourth means generating the RGBW signal by adding the W signal in the intermediate RGBW signal to the W signal of the calculated RGBW signal, when the minimum value in the RGB signal in the RGBW signal calculated by the third means is not zero; and fifth means for performing the same process as for the fourth means by setting the RGBW signal at the intermediate RGBW signal, the RGBW signal being obtained by the fourth means, when the minimum value in the RGB signal in the RGBW signal calculated by the fourth means is not zero.

According to the invention, there is provided a sixth signal processing circuit for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing circuit including: first means for calculating a ratio of each signal value of RGB to the W signal value as each RGB feedback ratio, based on an RGBW signal value for realizing the target white when all the RGB input signals are the maximum value; second means for calculating the sum of an infinite geometric series in each RGB, the RGB input signal being set at a first term, each RGB feedback ratio being set at a common ratio; third means for subtracting a minimum value in the sum of the infinite geometric series from each input signal of RGB, the sum of the infinite geometric series being calculated in each RGB by the second means; fourth means for calculating the RGBW signal corresponding to the case in which all the RGB input signals are the minimum value, based on the RGBW signal value for realizing the target white when all the RGB input signals are the maximum value; and fifth means for determining the RGBW signal by adding a signal corresponding to each RGB subtraction result to the RGBW signal calculated by the fourth means, each RGB subtraction result being calculated by the third means.

According to the invention, there is provided a seventh signal processing circuit for a self-luminous type display, in which one pixel includes four unit pixels of RGBW, color filters are provided in the RGB unit pixels respectively, and the color filter is not provided in the W unit pixel, the signal processing circuit including: reverse gamma correction means for converting an RGB input signal into a pre-gamma correction RGB signal by performing reverse gamma correction to the RGB input signal, gamma correction being previously performed to the RGB input signal; RGB-RGBW signal conversion means for setting the RGB signal at the RGB input signal to convert the RGB input signal into an RGBW signal, the RGB signal being obtained by the reverse gamma correction means; and gamma correction means for performing the gamma correction to the RGBW signal according to the self-luminous type display, the RGBW signal being obtained by the RGB-RGBW signal conversion means, wherein an RGBW signal value for realizing target white is set when all the RGB input signals obtained by the reverse gamma correction means are a maximum value, while white-side reference brightness of RGB is set such that the target white can be realized by only RGB when all the RGB input signals obtained by the reverse gamma correction means are the same value, and the RGB-RGBW signal conversion means includes: first means for calculating a ratio of each signal value of RGB to the W signal value as each RGB feedback ratio, based on an RGBW signal value for realizing the target white when all the RGB input signals are the maximum value; second means for calculating the sum of an infinite geometric series in each RGB, the RGB input signal being set at a first term, each RGB feedback ratio being set at a common ratio; third means for subtracting a minimum value in the sum of the infinite geometric series from each input signal of RGB, the sum of the infinite geometric series being calculated in each RGB by the second means; fourth means for calculating the RGBW signal corresponding to the case in which all the RGB input signals are the minimum value, based on the RGBW signal value for realizing the target white when all the RGB input signals are the maximum value; and fifth means for determining the RGBW signal by adding a signal corresponding to each RGB subtraction result to the RGBW signal calculated by the fourth means, each RGB subtraction result being calculated by the third means.

According to the invention, there is provided a first signal processing method for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing method including: a first step of subtracting a minimum value in RGB input signals from each input signal of RGB; a second step of calculating an RGBW signal corresponding to the case in which all the RGB input signals are the minimum value, based on an RGBW signal value for realizing target white when all the RGB input signals are a maximum value; and a third step of determining the RGBW signal by adding a signal corresponding to each RGB subtraction result to the RGBW signal calculated in the second step, each RGB subtraction result being calculated in the first step.

According to the invention, there is provided a second signal processing method for a self-luminous type display, in which one pixel includes four unit pixels of RGBW, color filters are provided in the RGB unit pixels respectively, and the color filter is not provided in the W unit pixel, the signal processing method including: a reverse gamma correction step of converting an RGB input signal into a pre-gamma correction RGB signal by performing reverse gamma correction to the RGB input signal, gamma correction being previously performed to the RGB input signal; an RGB-RGBW signal conversion step of setting the RGB signal at the RGB input signal to convert the RGB input signal into an RGBW signal, the RGB signal being obtained in the reverse gamma correction means; and a gamma correction step of performing the gamma correction to the RGBW signal according to the self-luminous type display, the RGBW signal being obtained in the RGB-RGBW signal conversion step, wherein an RGBW signal value for realizing target white is set when all the RGB input signals obtained in the reverse gamma correction step are a maximum value, while white-side reference brightness of RGB is set such that the target white can be realized by only RGB when all the RGB input signals obtained in the reverse gamma correction step are the same value, and the RGB-RGBW signal conversion step includes: a first step of subtracting a minimum value in RGB input signals from each input signal of RGB; a second step of calculating an RGBW signal corresponding to the case in which all the RGB input signals are the minimum value, based on an RGBW signal value for realizing target white when all the RGB input signals are a maximum value; and a third step of determining the RGBW signal by adding a signal corresponding to each RGB subtraction result to the RGBW signal calculated in the second step, each RGB subtraction result being calculated in the first step.

According to the invention, there is provided a third signal processing method for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing method including: a first step of subtracting a minimum value in RGB input signals from each input signal of RGB; a second step of calculating an RGBW signal corresponding to the case in which all the RGB input signals are the minimum value, based on an RGBW signal value for realizing target white when all the RGB input signals are a maximum value; a third step of determining the RGBW signal by adding a signal corresponding to each RGB subtraction result to the RGBW signal calculated in the second step, each RGB subtraction result being calculated in the first step; a fourth step of calculating the RGBW signal in the same manner as for the first step, the second step and the third step by setting the RGBW signal at an intermediate RGBW signal to regard the RGB signal in the intermediate RGBW signal as the RGB input signal, the RGBW signal being obtained in the third step, the fourth step generating the RGBW signal by adding the W signal in the intermediate RGBW signal to the W signal of the calculated RGBW signal, when the minimum value in the RGB signal in the RGBW signal calculated in the third step is not zero; and a fifth step of performing the same process as for the fourth step by setting the RGBW signal at the intermediate RGBW signal, the RGBW signal being obtained in the fourth step, when the minimum value in the RGB signal in the RGBW signal calculated in the fourth step is not zero.

According to the invention, there is provided a fourth signal processing method for a self-luminous type display, in which one pixel includes four unit pixels of RGBW, color filters are provided in the RGB unit pixels respectively, and the color filter is not provided in the W unit pixel, the signal processing method including: a reverse gamma correction step of converting an RGB input signal into a pre-gamma correction RGB signal by performing reverse gamma correction to the RGB input signal, gamma correction being previously performed to the RGB input signal; an RGB-RGBW signal conversion step of setting the RGB signal at the RGB input signal to convert the RGB input signal into an RGBW signal, the RGB signal being obtained in the reverse gamma correction step; and a gamma correction step of performing the gamma correction to the RGBW signal according to the self-luminous type display, the RGBW signal being obtained in the RGB-RGBW signal conversion step, wherein an RGBW signal value for realizing target white is set when all the RGB input signals obtained in the reverse gamma correction step are a maximum value, while white-side reference brightness of RGB is set such that the target white can be realized by only RGB when all the RGB input signals obtained in the reverse gamma correction step are the same value, and the RGB-RGBW signal conversion step includes: a first step of subtracting a minimum value in RGB input signals from each input signal of RGB; a second step of calculating an RGBW signal corresponding to the case in which all the RGB input signals are the minimum value, based on an RGBW signal value for realizing target white when all the RGB input signals are a maximum value; a third step of determining the RGBW signal by adding a signal corresponding to each RGB subtraction result to the RGBW signal calculated in the second step, each RGB subtraction result being calculated in the first step; a fourth step of calculating the RGBW signal in the same manner as for the first step, the second step and the third step by setting the RGBW signal at an intermediate RGBW signal to regard the RGB signal in the intermediate RGBW signal as the RGB input signal, the RGBW signal being obtained in the third step, the fourth step generating the RGBW signal by adding the W signal in the intermediate RGBW signal to the W signal of the calculated RGBW signal, when the minimum value in the RGB signal in the RGBW signal calculated in the third step is not zero; and a fifth step of performing the same process as for the fourth step by setting the RGBW signal at the intermediate RGBW signal, the RGBW signal being obtained in the fourth step, when the minimum value in the RGB signal in the RGBW signal calculated in the fourth step is not zero.

According to the invention, there is provided a fifth signal processing method for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing method including: a first step of calculating a ratio of each signal value of RGB to the W signal value as each RGB feedback ratio, based on an RGBW signal value for realizing the target white when all the RGB input signals are the maximum value; a second step of calculating the sum of an infinite geometric series in each RGB, the RGB input signal being set at a first term, each RGB feedback ratio being set at a common ratio; a third step of subtracting a minimum value in the sum of the infinite geometric -series from each input signal of RGB, the sum of the infinite geometric series being calculated in each RGB in the second step; a fourth step of calculating the RGBW signal corresponding to the case in which all the RGB input signals are the minimum value, based on the RGBW signal value for realizing the target white when all the RGB input signals are the maximum value; and a fifth step of determining the RGBW signal by adding a signal corresponding to each RGB subtraction result to the RGBW signal calculated in the fourth step, each RGB subtraction result being calculated in the third step.

According to the invention, there is provided a sixth signal processing method for a self-luminous type display, in which one pixel includes four unit pixels of RGBW, color filters are provided in the RGB unit pixels respectively, and the color filter is not provided in the W unit pixel, the signal processing method including: a reverse gamma correction step of converting an RGB input signal into a pre-gamma correction RGB signal by performing reverse gamma correction to the RGB input signal, gamma correction being previously performed to the RGB input signal; an RGB-RGBW signal conversion step of setting the RGB signal at the RGB input signal to convert the RGB input signal into an RGBW signal, the RGB signal being obtained in the reverse gamma correction step; and a gamma correction step of performing the gamma correction to the RGBW signal according to the self-luminous type display, the RGBW signal being obtained in the RGB-RGBW signal conversion step, wherein an RGBW signal value for realizing target white is set when all the RGB input signals obtained in the reverse gamma correction step are a maximum value, while white-side reference brightness of RGB is set such that the target white can be realized by only RGB when all the RGB input signals obtained in the reverse gamma correction step are the same value, and the RGB-RGBW signal conversion step includes: a first step of calculating a ratio of each signal value of RGB to the W signal value as each RGB feedback ratio, based on an RGBW signal value for realizing the target white when all the RGB input signals are the maximum value; a second step of calculating the sum of an infinite geometric series in each RGB, the RGB input signal being set at a first term, each RGB feedback ratio being set at a common ratio; a third step of subtracting a minimum value in the sum of the infinite geometric series from each input signal of RGB, the sum of the infinite geometric series being calculated in each RGB in the second step; a fourth step of calculating the RGBW signal corresponding to the case in which all the RGB input signals are the minimum value, based on the RGBW signal value for realizing the target white when all the RGB input signals are the maximum value; and a fifth step of determining the RGBW signal by adding a signal corresponding to each RGB subtraction result to the RGBW signal calculated in the fourth step, each RGB subtraction result being calculated in the third step.

According to the invention, there is provided an eighth signal processing circuit for a self-luminous type display, in which one pixel includes four unit pixels of RGBX, an arbitrary color except for RGB is set at X, and an RGB signal value for realizing chromaticity and maximum brightness of X is set by an RGB signal, the signal processing circuit including RGB-RGBX signal conversion means for converting an RGB input signal into an RGBX signal, wherein the RGB-RGBX signal conversion means includes: first means for calculating an RGB signal component, based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal; second means for subtracting the RGB signal component from the RGB input signal to output the subtraction result as the RGB signal, the RGB signal component being calculated by the first means; and third means for outputting the X signal corresponding to the RGB signal component calculated by the first means.

According to the invention, there is provided a ninth signal processing circuit for a self-luminous type display, in which one pixel includes four unit pixels of RGBX and an arbitrary color except for RGB is set at X, the signal processing circuit including: reverse gamma correction means for converting an RGB input signal into a pre-gamma correction RGB signal by performing reverse gamma correction to the RGB input signal, gamma correction being previously performed to the RGB input signal; RGB-RGBX signal conversion means for setting the RGB signal at the RGB input signal to convert the RGB input signal into an RGBX signal, the RGB signal being obtained by the reverse gamma correction means; and gamma correction means for performing the gamma correction to the RGBX signal according to the self-luminous type display, the RGBX signal being obtained by the RGB-RGBX signal conversion means, wherein an RGB signal value for realizing chromaticity and maximum brightness of X is set by the RGB signal with respect to the pre-gamma correction RGB signal obtained by the reverse gamma correction means, and the RGB-RGBX signal conversion means includes: first means for calculating an RGB signal component based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal; second means for subtracting the RGB signal component from the RGB input signal to output the subtraction result as the RGB signal, the RGB signal component being calculated by the first means; and third means for outputting the X signal corresponding to the RGB signal component calculated by the first means.

According to the invention, there is provided a seventh signal processing method for a self-luminous type display, in which one pixel includes four unit pixels of RGBX, an arbitrary color except for RGB is set at X, and an RGB signal value for realizing chromaticity and maximum brightness of X is set by an RGB signal, the signal processing method including an RGB-RGBX signal conversion step of converting an RGB input signal into an RGBX signal, wherein the RGB-RGBX signal conversion step includes: a first step of calculating an RGB signal component based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal; a second step of subtracting the RGB signal component from the RGB input signal to output the subtraction result as the RGB signal, the RGB signal component being calculated in the first step; and a third step of outputting the X signal corresponding to the RGB signal component calculated in the first step.

According to the invention, there is provided an eighth signal processing method for a self-luminous type display, in which one pixel includes four unit pixels of RGBX and an arbitrary color except for RGB is set at X, the signal processing method including: a reverse gamma correction step of converting an RGB input signal into a pre-gamma correction RGB signal by performing reverse gamma correction to the RGB input signal, gamma correction being previously performed to the RGB input signal; an RGB-RGBX signal conversion step of setting the RGB signal at the RGB input signal to convert the RGB input signal into an RGBX signal, the RGB signal being obtained in the reverse gamma correction step; and a gamma correction step of performing the gamma correction to the RGBX signal according to the self-luminous type display, the RGBX signal being obtained in the RGB-RGBX signal conversion step, wherein an RGB signal value for realizing chromaticity and maximum brightness of X is set by the RGB signal with respect to the pre-gamma correction RGB signal obtained in the reverse gamma correction step, and the RGB-RGBX signal conversion step includes: a first step of calculating an RGB signal component based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal; a second step of subtracting the RGB signal component from the RGB input signal to output the subtraction result as the RGB signal, the RGB signal component being calculated in the first step; and a third step of outputting the X signal corresponding to the RGB signal component calculated in the first step.

According to the invention, there is provided a tenth signal processing circuit for a self-luminous type display, in which one pixel includes five unit pixels of RGBWX, an arbitrary color except for RGBW is set at X, color filters are provided in the RGBX unit pixels respectively, the color filter is not provided in the W unit pixel, and an RGBW signal value for realizing target white is set when all the RGB input signals are a maximum value, and an RGB signal value for realizing chromaticity and maximum brightness of X by an RGB signal is set, while white-side reference brightness of RGB is set such that the target white can be realized by only RGB when all the RGB input signals are the same value, the signal processing circuit including RGB-RGBWX signal conversion means for converting the RGB input signal into an RGBWX signal, wherein the RGB-RGBWX signal conversion means includes: first means for subtracting a minimum value in RGB input signals from each input signal of RGB; second means for calculating an RGBW signal corresponding to the case in which all the RGB input signals are the minimum value, based on an RGBW signal value for realizing target white when all the RGB input signals are a maximum value; third means for determining a first R signal, a first G signal, a first B signal, and a W signal by adding a signal corresponding to each RGB subtraction result to the RGBW signal calculated by the second means, each RGB subtraction result being calculated by the first means; fourth means for calculating an RGB signal component based on the RGB signal value for realizing chromaticity and maximum brightness of X by the RGB signal such that at least one of RGB subtraction results becomes zero, when the RGB signal component is subtracted from the first R signal, the first G signal, and the first B signal, the RGB signal component being able to be converted into an X signal from the first R signal, the first G signal, and the first B signal obtained by the third means; fifth means for calculating a second R signal, a second G signal, and a second B signal by subtracting the RGB signal component from the first R signal, the first G signal, and the first B signal, the RGB signal component being calculated by the first means; sixth means for calculating the X signal corresponding to the RGB signal component calculated by the fourth means; and seventh means for outputting the W signal, the second R signal, the second G signal, the second B signal, and the X signal as the RGBWX signal corresponding to the RGB input signal, the W signal being obtained by the third means, the second R signal, the second G signal, and the second B signal being obtained by the fifth means, the X signal being obtained by the sixth means.

According to the invention, there is provided an eleventh signal processing circuit for a self-luminous type display, in which one pixel includes five unit pixels of RGBWX, an arbitrary color except for RGBW is set at X, color filters are provided in the RGBX unit pixels respectively, and the color filter is not provided in the W unit pixel, the signal processing circuit including: reverse gamma correction means for converting an RGB input signal into a pre-gamma correction RGB signal by performing reverse gamma correction to the RGB input signal, gamma correction being previously performed to the RGB input signal; RGB-RGBWX signal conversion means for setting the RGB signal at the RGB input signal to convert the RGB input signal into an RGBWX signal, the RGB signal being obtained by the reverse gamma correction means; and gamma correction means for performing the gamma correction to the RGBWX signal according to the self-luminous type display, the RGBWX signal being obtained by the RGB-RGBWX signal conversion means, wherein an RGBW signal value for realizing target white is set when all the RGB input signals obtained by the reverse gamma correction means are a maximum value, and an RGB signal value for realizing chromaticity and maximum brightness of X by the RGB signal obtained by the reverse gamma correction means is set, while white-side reference brightness of RGB is set such that the target white can be realized by only RGB when all the RGB input signals obtained by the reverse gamma correction means are the same value, and the RGB-RGBWX signal conversion means includes: first means for subtracting a minimum value in RGB input signals from each input signal of RGB; second means for calculating an RGBW signal corresponding to the case in which all the RGB input signals are the minimum value, based on an RGBW signal value for realizing target white when all the RGB input signals are a maximum value; third means for determining a first R signal, a first G signal, a first B signal, and a W signal by adding a signal corresponding to each RGB subtraction result to the RGBW signal calculated by the second means, each RGB subtraction result being calculated by the first means; fourth means for calculating an RGB signal component based on the RGB signal value for realizing chromaticity and maximum brightness of X by the RGB signal such that at least one of RGB subtraction results becomes zero, when the RGB signal component is subtracted from the first R signal, the first G signal, and the first B signal, the RGB signal component being able to be converted into an X signal from the first R signal, the first G signal, and the first B signal obtained by the third means; fifth means for calculating a second R signal, a second G signal, and a second B signal by subtracting the RGB signal component from the first R signal, the first G signal, and the first B signal, the RGB signal component being obtained by the first means; sixth means for calculating the X signal corresponding to the RGB signal component calculated by the fourth means; and seventh means for outputting the W signal, the second R signal, the second G signal, the second B signal, and the X signal as the RGBWX signal corresponding to the RGB input signal, the W signal being obtained by the third means, the second R signal, the second G signal, and the second B signal being obtained by the fifth means, the X signal being obtained by the sixth means.

According to the invention, there is provided a ninth signal processing method for a self-luminous type display, in which one pixel includes five unit pixels of RGBWX, an arbitrary color except for RGBW is set at X, color filters are provided in the RGBX unit pixels respectively, the color filter is not provided in the W unit pixel, and an RGBW signal value for realizing target white is set when all the RGB input signals are a maximum value, and an RGB signal value for realizing chromaticity and maximum brightness of X by an RGB signal is set, while white-side reference brightness of RGB is set such that the target white can be realized by only RGB when all the RGB input signals are the same value, the signal processing method including an RGB-RGBWX signal conversion step of converting the RGB input signal into an RGBWX signal, wherein the RGB-RGBWX signal conversion step includes: a first step of subtracting a minimum value in RGB input signals from each input signal of RGB; a second step of calculating an RGBW signal corresponding to the case in which all the RGB input signals are the minimum value, based on an RGBW signal value for realizing target white when all the RGB input signals are a maximum value; a third step of determining a first R signal, a first G signal, a first B signal, and a W signal by adding a signal corresponding to each RGB subtraction result to the RGBW signal calculated in the second step, each RGB subtraction result being calculated in the first step; a fourth step of calculating an RGB signal component based on the RGB signal value for realizing chromaticity and maximum brightness of X by the RGB signal such that at least one of RGB subtraction results becomes zero when the RGB signal component is subtracted from the first R signal, the first G signal, and the first B signal, the RGB signal component being able to be converted into an X signal from the first R signal, the first G signal, and the first B signal obtained in the third step; a fifth step of calculating a second R signal, a second G signal, and a second B signal by subtracting the RGB signal component from the first R signal, the first G signal, and the first B signal, the RGB signal component being calculated in the first step; a sixth step of calculating the X signal corresponding to the RGB signal component calculated in the fourth step; and a seventh step of outputting the W signal, the second R signal, the second G signal, the second B signal, and the X signal as the RGBWX signal corresponding to the RGB input signal, the W signal being obtained in the third step, the second R signal, the second G signal, and the second B signal being obtained in the fifth step, the X signal being obtained in the sixth step.

According to the invention, there is provided a tenth signal processing method for a self-luminous type display, in which one pixel includes five unit pixels of RGBWX, an arbitrary color except for RGBW is set at X, color filters are provided in the RGBX unit pixels respectively, and the color filter is not provided in the W unit pixel, the signal processing method including: a reverse gamma correction step of converting an RGB input signal into a pre-gamma correction RGB signal by performing reverse gamma correction to the RGB input signal, gamma correction being previously performed to the RGB input signal; an RGB-RGBWX signal conversion step of setting the RGB signal at the RGB input signal to convert the RGB input signal into an RGBWX signal, the RGB signal being obtained in the reverse gamma correction step; and a gamma correction step of performing the gamma correction to the RGBWX signal according to the self-luminous type display, the RGBWX signal being obtained in the RGB-RGBWX signal conversion step, wherein an RGBW signal value for realizing target white is set when all the RGB input signals obtained in the reverse gamma correction step are a maximum value, and an RGB signal value for realizing chromaticity and maximum brightness of X by the RGB signal obtained in the reverse gamma correction step is set, while white-side reference brightness of RGB is set such that the target white can be realized by only RGB when all the RGB input signals obtained in the reverse gamma correction step are the same value, and the RGB-RGBW signal conversion step includes: a first step of subtracting a minimum value in RGB input signals from each input signal of RGB; a second step of calculating an RGBW signal corresponding to the case in which all the RGB input signals are the minimum value, based on an RGBW signal value for realizing target white when all the RGB input signals are a maximum value; a third step of determining a first R signal, a first G signal, a first B signal, and a W signal by adding a signal corresponding to each RGB subtraction result to the RGBW signal calculated in the second step, each RGB subtraction result being calculated in the first step; a fourth step of calculating an RGB signal component based on the RGB signal value for realizing chromaticity and maximum brightness of X by the RGB signal such that at least one of RGB subtraction results becomes zero, when the RGB signal component is subtracted from the first R signal, the first G signal, and the first B signal, the RGB signal component being able to be converted into an X signal from the first R signal, the first G signal, and the first B signal obtained in the third step; a fifth step of calculating a second R signal, a second G signal, and a second B signal by subtracting the RGB signal component from the first R signal, the first G signal, and the first B signal, the RGB signal component being calculated in the first step; a sixth step of calculating the X signal corresponding to the RGB signal component calculated in the fourth step; and a seventh step of outputting the W signal, the second R signal, the second G signal, the second B signal, and the X signal as the RGBWX signal corresponding to the RGB input signal, the W signal being obtained in the third step, the second R signal, the second G signal, and the second B signal being obtained in the fifth step, the X signal being obtained in the sixth step.

### BRIEF DESCRIPTION OF THE DRAWINGS

FIG. 1 is a schematic view showing an example in which one pixel includes four units R, G, B, and W;

FIG. 2 is a block diagram showing a configuration of a display device;

FIG. 3 is a schematic view showing an example of an RGB input signal;

FIG. 4 is a schematic view showing min(RGB);

FIG. 5 is a schematic view showing input signal−min(RGB);

FIG. 6 is a schematic view showing an RGBW signal ratio for expressing Wₜ(255);

FIG. 7 is a schematic view showing the RGBW signal ratio for realizing Wₜ(100);

FIG. 8 is a schematic view showing an RGBW value determined by adding the RGB value of FIG. 5 and the RGBW value of FIG. 7;

FIG. 9 is a flowchart showing a panel adjusting process;

FIG. 10 is a schematic view showing RGBW chromaticity coordinates (x_{R}, y_{R}), (x_{G}, y_{G}), (x_{B}, y_{B}), and (x_{W}, y_{W}) and the chromaticity coordinate (x_{Wt}, y_{Wt}) of a target white Wₜ;

FIG. 11 is a flowchart showing a signal converting process for converting an RGB input signal into an RGBW signal;

FIG. 12 is a flowchart showing another example of the signal converting process for converting the RGB input signal into the RGBW signal;

FIG. 13 is a schematic view showing an example of the RGB input signal;

FIG. 14 is a schematic view showing RGB input signal−min(RGB);

FIG. 15 is a schematic view showing the min(RGB);

FIG. 16 is a schematic view showing the RGBW signal corresponding to the min(RGB);

FIG. 17 is a schematic view showing the RGBW value determined by adding the RGB value of FIG. 14 and the RGBW value of FIG. 16;

FIG. 18 is a schematic view showing an R₁G₁B₁W₁ input signal when the obtained RGBW signal is set at the R₁G₁B₁W₁ input signal;

FIG. 19 is a schematic view showing R₁G₁B₁ input signal-min(R₁G₁B₁);

FIG. 20 is a schematic view showing min(R₁G₁B₁);

FIG. 21 is a schematic view showing the RGBW signal corresponding to the min(R₁G₁B₁);

FIG. 22 is a schematic view showing the RGBW value determined by adding the R₁G₁B₁ value of FIG. 19 and the R₁G₁B₁W₁ value of FIG. 21;

FIG. 23 is a flowchart showing still another example of the signal converting process for converting the RGB input signal into the RGBW signal;

FIG. 24 is a block diagram showing the configuration of the display device;

FIG. 25 is a schematic view showing an example in which one pixel includes four units R, G, B, and Ye;

FIG. 26 is a block diagram showing the configuration of the display device;

FIG. 27 is a flowchart showing an RGB reference adjusting process;

FIG. 28 is a schematic view showing the RGB chromaticity coordinate and the chromaticity coordinate of the target white Wₜ;

FIG. 29 is a flowchart showing a Ye reference adjusting process;

FIG. 30 is a schematic view showing the RGB chromaticity coordinate, the chromaticity coordinate of the target white Wₜ, and the Ye chromaticity coordinate;

FIG. 31 is a flowchart showing an RGB-RGBYe signal converting process by an RGB-RGBYe signal conversion circuit 22;

FIG. 32 is a schematic view showing an example of the RGB input signal;

FIG. 33 is a schematic view showing an RGB signal component α(R_{ye}, G_{ye}, B_{ye}) converted into the Ye signal when the RGB input signal is the signal shown in FIG. 32;

FIG. 34 is a schematic view showing the RGBYe signal obtained by the RGB-RGBYe signal conversion circuit 22 when the RGB input signal is the signal shown in FIG. 32;

FIG. 35 is a block diagram showing the configuration of the display device;

FIG. 36 is a schematic view showing an example in which one pixel includes five units R, G, B, W, and Ye;

FIG. 37 is a flowchart showing a RGBW white-side reference adjusting process;

FIG. 38 is a schematic view showing the RGB chromaticity coordinate and the chromaticity coordinate of the target white Wₜ;

FIG. 39 is a flowchart showing the Ye reference adjusting process;

FIG. 40 is a schematic view showing the RGB chromaticity coordinate, the chromaticity coordinate of the target white Wₜ, and the Ye chromaticity coordinate;

FIG. 41 is a functional block diagram showing the configuration of an RGB-RGBWYe conversion circuit;

FIG. 42 is a schematic view showing an example of the RGB input signal;

FIG. 43 is a schematic view showing the min(RGB);

FIG. 44 is a schematic view showing the input signal−min(RGB);

FIG. 45 is a schematic view showing an RGBW signal value for expressing Wₜ(255);

FIG. 46 is a schematic view showing the RGBW signal value for realizing Wₜ(100);

FIG. 47 is a schematic view showing the RGBW value determined by adding the RGB value of FIG. 43 and the RGBW value of FIG. 46;

FIG. 48 is a flowchart showing the signal converting process for converting the RGB input signal into the RGBW signal;

FIG. 49 is a flowchart showing the RGB-RGBYe signal converting process by RGB-RGBYe signal conversion means 132;

FIG. 50 is a schematic view showing an RGB signal component α(R_{ye}, G_{ye}, B_{ye}) converted into the Ye signal when the RGB input signal is the signal shown in FIG. 47;

FIG. 51 is a schematic view showing the RGBYe signal obtained by the RGB-RGBYe signal conversion means 132 when the RGB input signal is the signal shown in FIG. 47; and

FIG. 52 is a schematic view showing the RGBWYe signal obtained by an RGB-RGBWYe conversion circuit 122 when the RGB input signal inputted to the RGB-RGBWYe conversion circuit 122 is the signal shown in FIG. 42.

### DESCRIPTION OF THE PREFERRED EMBODIMENTS

Referring now to the accompanying drawings, preferred embodiments of the invention will be described.

### First Embodiment

(A) RGB-RGBW Signal Conversion

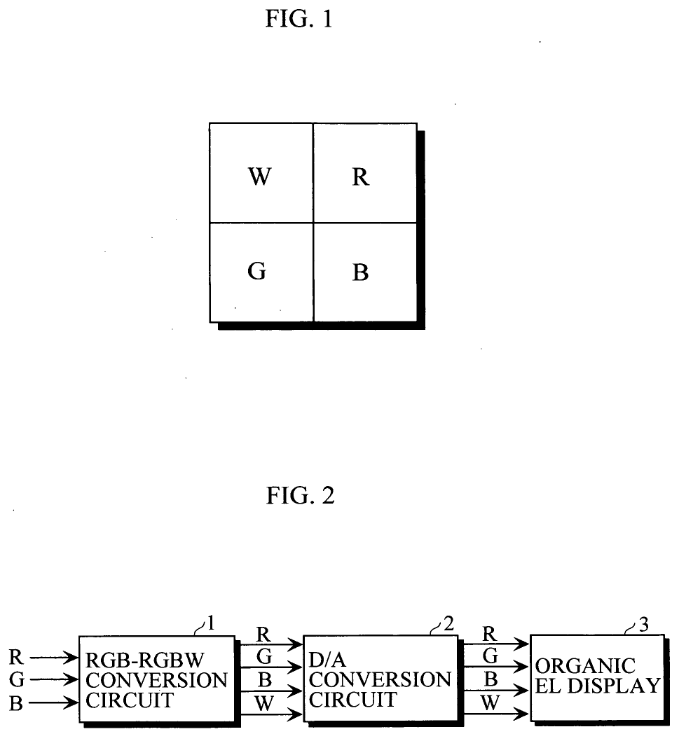

The invention is directed to the self-luminous type display such as the organic EL display in which the color filter is affixed to the self-luminous material. As shown in FIG. 1, one pixel includes four unit pixels in the self-luminous type display. The color filters are provided to three unit pixels in the four unit pixels in order to display three primary colors such as R (Red), G (Green), and B (Blue). The remaining one unit pixel in which the color filter is not provided is dedicated to W (White) display.

In the RGBW array, since the white display dedicated unit pixel has no color filter, the light usable efficiency is extremely high. Therefore, in order to display 100% white, when the display is performed not by the light emission of the RGB display unit pixels, but by the light emission of the white display dedicated unit pixel, electrical power consumption is largely reduced.

However, actually the white chromaticity obtained by the self-luminous type material does not frequently reach the target white chromaticity, so that it is necessary that the light emission of the RGB display unit pixels is added to the light emission of the white display dedicated unit pixel.

Therefore, the invention proposes a signal processing technique in which the RGB input signal is converted into the RGBW signal when the white chromaticity obtained by the self-luminous type display differs from the target white chromaticity.

1. Configuration of Display Device

FIG. 2 shows a configuration of a display device.

A digital RGB input signal is inputted to an RGB-RGBW signal conversion circuit 1. The RGB-RGBW signal conversion circuit 1 converts the RGB input signal into an RGBW signal. The RGBW signal obtained by the RGB-RGBW signal conversion circuit 1 is converted into the analog RGBW signal by a D/A conversion circuit 2. The RGBW signal obtained by the D/A conversion circuit 2 is transmitted to an organic EL display 3 in which one pixel includes four unit pixels of RGBW.

2. Basic Concept of RGB-RGBW Signal Conversion

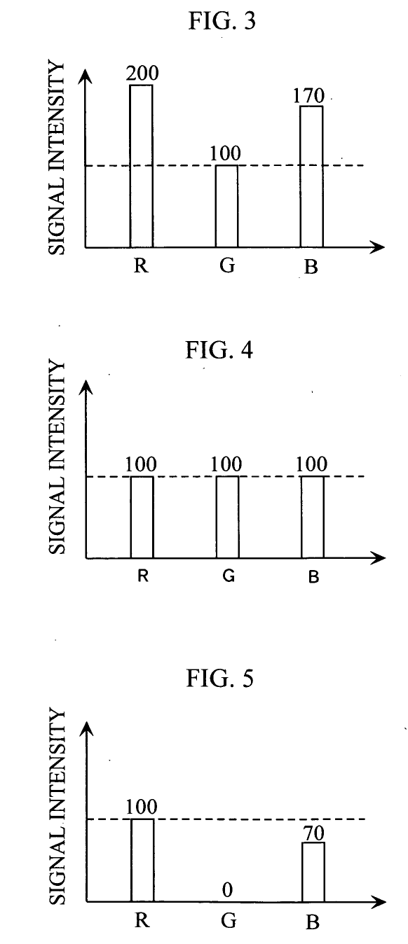

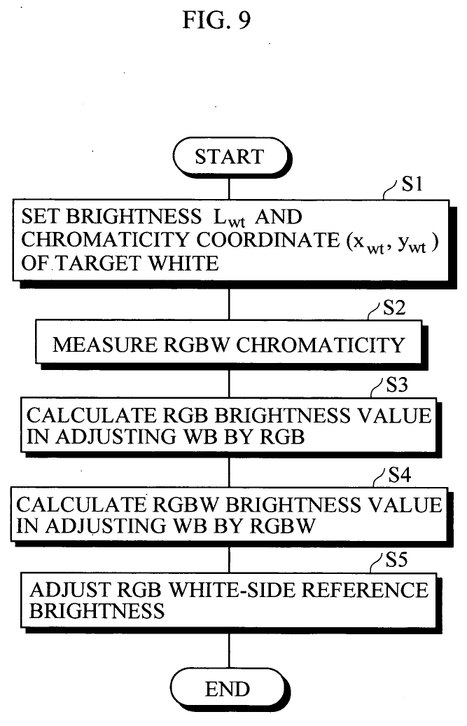

The RGB input signal shown in FIG. 3 is assumed. For the sake of convenience, it is assumed that the gamma correction is not previously performed to the RGB input signal. Further, it is assumed that RGB brightness in which the target white brightness and chromaticity are realized only by RGB is previously set as the RGB white-side reference brightness (white-side reference voltage to RGB of the D/A conversion circuit 2). The white-side reference brightness of W is adjusted so as to become the target brightness (W brightness determined in the later-mentioned step S4 of FIG. 9) when only W is displayed.

In this example, it is assumed that an RGB input signal value is expressed in terms of eight bits, the R input signal value is 200, the G input signal value is 100, and the B input signal value is 170. Because the minimum value of the RGB input signal values is 100, the RGB input signal values are divided into the minimum values (min(RGB) shown in FIG. 4 and the remaining values (input signal−min(RGB)) shown in FIG. 5. In FIG. 4, the RGB input signal values are equal to the value of the target white Wₜ(100) when all the RGB input signal values are 100.

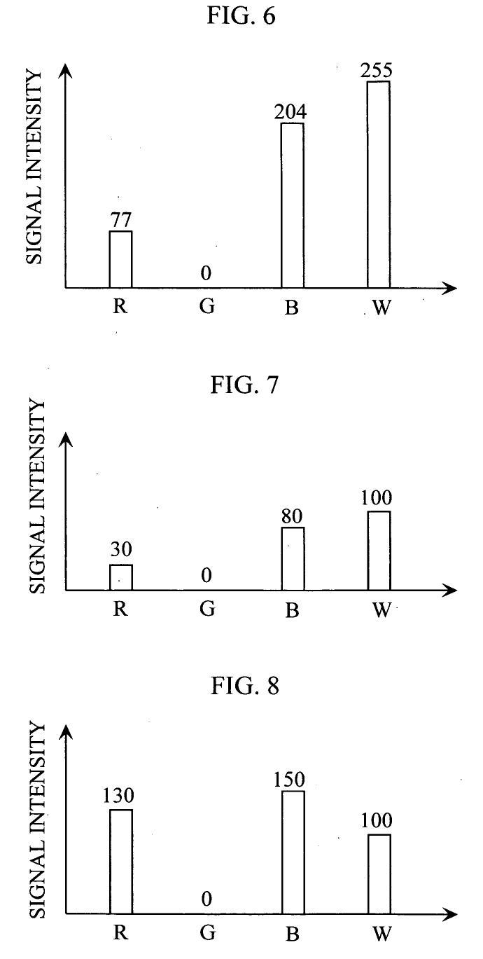

In the case where all the RGB input signal values are 255, assuming that the RGBW signal values is the signal value (77, 0, 204, 255) shown in FIG. 6 in order to express the target white Wₜ(255), the RGBW signal value for realizing the target white Wₜ(100) becomes the RGBW signal values shown in. FIG. 7 when all the RGB input signal values are 100.

The signal values shown in FIG. 6 can be determined by an RGB brightness value and an RGBW brightness value for realizing the target white. It is assumed that the RGBW signal value is set at (R1, G1, B1, W1) in order to realize the target white when all the RGB input signal values are 255. Assuming that the RGB brightness value for realizing the brightness and chromaticity of the target white is (LR1, LG1, LB1) and the RGBW brightness value for realizing the brightness and chromaticity of the target white is (LR2, LG2, LB2, LW2), the RGBW signal value for realizing the target white becomes (R1=255×LR2/LR1, G1=255×LG2/LG1, B1=255×LB2/LB1, W1=255) when all the RGB input signal values are 255. Particularly, since the W signal can be defined only by an RGBW display system, the W signal becomes uniquely 255. A method of determining the RGB brightness value and RGBW brightness value for realizing the brightness and chromaticity of the target white will be described later.

R, G, B, and W of FIG. 7 are obtained by the following equation (1).
R=77×100/255=30
G=0×100/255=0
B=204×100/255=80
W=255×100/255=100 (1)

The RGBW values of FIG. 7 are substituted for the RGB value of FIG. 4. Therefore, the RGB value shown in FIG. 3 is converted into the RGBW value shown in FIG. 8 by adding the RGB value of FIG. 5 and the RGBW value of FIG. 7.

R, G, B, and W of FIG. 8 are obtained by the following equation (2).
R=100+30=130
G=0+0=0
B=70+80=150
W=0+100=100 (2)

The RGB white-side reference brightness (the RGB brightness value for realizing the brightness and chromaticity of the target white), the RGBW brightness value for expressing the brightness and chromaticity of the target white, and the RGBW signal value for realizing the target white when all the RGB input signal values are 255 are previously determined by a panel adjusting process.

3. RGB-RGBW Signal Conversion Process

FIG. 9 shows a panel adjusting process.

Brightness L_{Wt} and a chromaticity coordinate (x_{Wt}, y_{Wt}) of the target white Wₜ are set (step S1).

Then, the RGBW chromaticity is measured in the organic EL display 3 (step S2). For example, when the R chromaticity is measured, only the R display unit pixel in the organic EL display 3 is light-emitted and the chromaticity of the R display unit pixel is measured with an optical measurement system. The measured RGBW chromaticity coordinates are set at (x_{R}, y_{R}), (x_{G}, y_{G}), (x_{B}, y_{B}), and (x_{W}, y_{W}), respectively.

Then, the RGB brightness value in adjusting white balance (WB) by RGB is calculated (step S3). Namely, the RGB brightness values L_{R} (corresponding to LR1), L_{G} (corresponding to LG1), and L_{B} (corresponding to LB1) in expressing the brightness L_{Wt} and chromaticity (x_{Wt}, y_{Wt}) of the target white Wₜ are calculated by the three colors of RGB. The brightness values L_{R}, L_{G}, and L_{B} are obtained by the following equation (3).

$$( \begin{matrix}\frac{{x}_{R}}{{y}_{R}} & \frac{{x}_{G}}{{y}_{G}} & \frac{{x}_{B}}{{y}_{B}} \\ 1.0 & 1.0 & 1.0 \\ \frac{{z}_{R}}{{y}_{R}} & \frac{{z}_{G}}{{y}_{G}} & \frac{{z}_{B}}{{y}_{B}}\end{matrix} ) ( \begin{matrix}{L}_{R} \\ {L}_{G} \\ {L}_{B}\end{matrix} ) = ( \begin{matrix}\frac{{x}_{wt}}{{y}_{wt}} {L}_{wt} \\ {L}_{wt} \\ \frac{{z}_{wt}}{{y}_{wt}} {L}_{wt}\end{matrix} ) \qquad ( 3 )$$

Herein, z_{R}=1−x_{R}−y_{R}, z_{G}=1−x_{G}−y_{G}, z_{B}=1−x_{B}−y_{B}, and z_{Wt}=1−x_{Wt}−y_{Wt}.

Then, the RGBW brightness value in adjusting the white balance (WB) by RGBW is calculated (step S4). Namely, the RGBW brightness values L_{R} (corresponding to LR2), L_{G} (corresponding to LG2), L_{B} (corresponding to LB2), and L_{W} (corresponding to LW2) in expressing the brightness L_{Wt} and chromaticity (x_{Wt}, y_{Wt}) of the target white Wₜ are calculated by the four colors of RGBW.

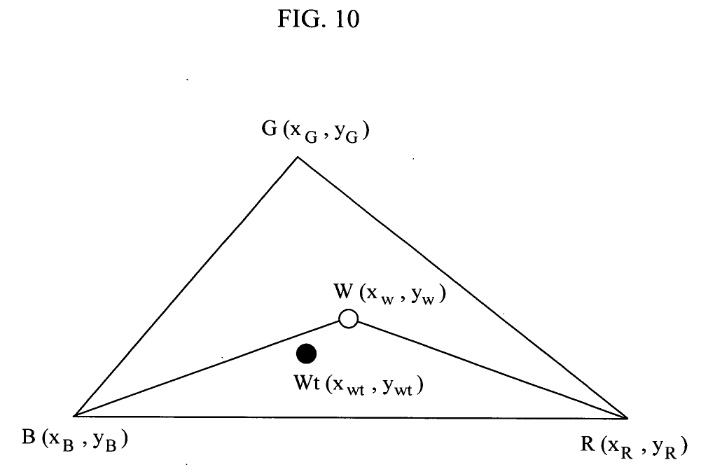

Assuming that there is a relationship shown in FIG. 10 between the RGBW chromaticity coordinate (x_{R}, y_{R}), (x_{G}, y_{G}), (x_{B}, y_{B}), and (x_{W}, y_{W}) and the chromaticity coordinate (x_{Wt}, y_{Wt}) of the target white Wₜ, the chromaticity of the target white Wₜ can be expressed only by the three colors of RBW. The RBW brightness values L_{R} (corresponding to LR2), L_{B} (corresponding to LB2), and L_{W} (corresponding to LW2) in expressing the brightness L_{Wt} and chromaticity (x_{Wt}, y_{Wt}) of the target white Wₜ are obtained from the following equation (4). In this case, L_{G} corresponding to LG2 becomes zero.

$$( \begin{matrix}\frac{{x}_{R}}{{y}_{R}} & \frac{{x}_{w}}{{y}_{w}} & \frac{{x}_{B}}{{y}_{B}} \\ 1.0 & 1.0 & 1.0 \\ \frac{{z}_{R}}{{y}_{R}} & \frac{{z}_{w}}{{y}_{w}} & \frac{{z}_{B}}{{y}_{B}}\end{matrix} ) ( \begin{matrix}{L}_{R} \\ {L}_{w} \\ {L}_{B}\end{matrix} ) = ( \begin{matrix}\frac{{x}_{wt}}{{y}_{wt}} {L}_{wt} \\ {L}_{wt} \\ \frac{{z}_{wt}}{{y}_{wt}} {L}_{wt}\end{matrix} ) \qquad ( 4 )$$

Herein, z_{R}=1−x_{R}−y_{R}, z_{W}=1−x_{W}−y_{W}, z_{B}=1−x_{B-y}_{B}, and z_{Wt}=1−x_{Wt}−y_{Wt}.

Then, the RGB white-side reference brightness is calculated using the calculation result in step S3 (step S5).

In the case where the RGB input signal value is expressed in terms of eight bits, the RGB white-side reference brightness is adjusted so that light-emission brightness and light-emission color become the brightness L_{Wt} and chromaticity (x_{Wt}, y_{Wt}) of the target white Wₜ when (255, 255, 255) is inputted as the RGB signal. Namely, the RGB white-side reference brightness is adjusted so that the RGB brightness values become the brightness values L_{R}, L_{G}, and L_{B} calculated in step S3 respectively when (255, 255, 255) is inputted as the RGB signal. Thus, when the RGB white-side reference brightness is adjusted, the light-emission color always becomes the chromaticity of the target white in the case where the input RGB signals have the same value. The W white-side reference brightness is adjusted so as to become the target brightness (the W brightness value L_{W} determined in step S4 of FIG. 9) when only W is displayed.

The RGBW signal value for realizing the target white Wₜ(255) when all the RGB input signal values are 255 is previously calculated from the brightness values L_{R} (corresponding to LR1), L_{G} (corresponding to LG1), and L_{B} (corresponding to LB1) calculated in step S3 of the panel adjusting process and the RGBW brightness values L_{R} (corresponding to LR2), L_{G} (corresponding to LG2), L_{B} (corresponding to LB2), and L_{W} (corresponding to LW2) calculated in step S4.

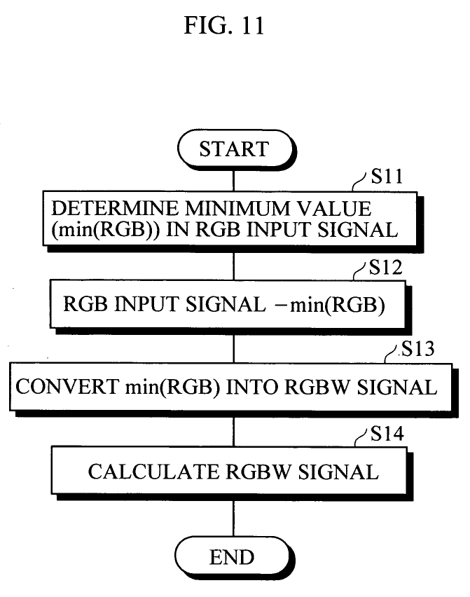

FIG. 11 shows a signal converting process for converting the RGB input signal into the RGBW signal.

First, the minimum value min(RGB) is determined in the RGB input signals (step S11). In an example of FIG. 3, min(RGB) is 100.

The minimum value min(RGB) is subtracted from each RGB input signal (step S12). In the example of FIG. 3, as shown in FIG. 5, the subtraction results to RGB become 100, 0, and 70 respectively.

Then, the minimum value min(RGB) is converted into the RGBW signal using the RGBW signal value for expressing the target white Wₜ(255) when all the RGB input signal values are 255 (step S13). When the RGBW signal value for realizing the target white Wₜ(255) is the signal value shown in FIG. 6, in the example of FIG. 3, the RGBW signal value corresponding to min(RGB) becomes shown in FIG. 7.

Then, the RGBW signal corresponding to the RGB input signal is calculated by adding the RGBW signal value determined in step S13 to the subtraction value (RGB−min(RGB)) calculated in step S12 (step S14). In the example of FIG. 3, the RGBW signal value corresponding to the RGB input signal becomes shown in FIG. 8.

4. First Modification of RGB-RGBW Signal Conversion

In the case where not only the chromaticity of the target white can be expressed only by the three colors of RBW but also the minimum value is the G signal in the RGB input signals, the RGBW signal in which one signal (G signal) of the RGB signals becomes zero can be obtained through the processes (RGB-RGBW converting routine) from step S11 to step S14 of FIG. 11.

In the case where not only the chromaticity of the target white can be expressed only by the three colors of RGW but also the minimum value is the B signal in the RGB input signals, similarly the RGBW signal in which one signal (B signal) of the RGB signals becomes zero can be obtained through the processes (RGB-RGBW converting routine) from step S11 to step S14 of FIG. 11. In the case where not only the chromaticity of the target white can be expressed only by the three colors of GBW but also the minimum value is the R signal in the RGB input signals, similarly the RGBW signal in which one signal (R signal) of the RGB signals becomes zero can be obtained through the processes (RGB-RGBW converting routine) from step S11 to step S14 of FIG. 11.

However, in the case where not only the chromaticity of the target white can be expressed only by the three colors of RBW but also the minimum value in the RGB input signals is the color signal except for the G signal, in the case where not only the chromaticity of the target white can be expressed only by the three colors of RGW but also the minimum value in the RGB input signals is the color signal except for the B signal, or in the case where not only the chromaticity of the target white can be expressed only by the three colors of GBW but also the minimum value in the RGB input signals is the color signal except for the R signal, one signal in the obtained RGBW signals does not become zero only by performing the one-time processes (RGB-RGBW converting routine) from step S11 to step S14 of FIG. 11.

Namely, depending on the conditions, one signal of the RGB signals in the obtained RGBW signals does not become zero by performing the only one-time RGB-RGBW converting routine.

When the RGB input signal is converted into the RGBW signal so that one signal in the RGB signals becomes zero in the RGBW signal, the magnitude of the W signal is increased, the light-emission efficiency is enhanced, and the low-electrical power consumption is achieved.

Therefore, the first modification proposes the signal converting method for obtaining the RGBW signal in which one signal in the RGB signals becomes zero despite the conditions.

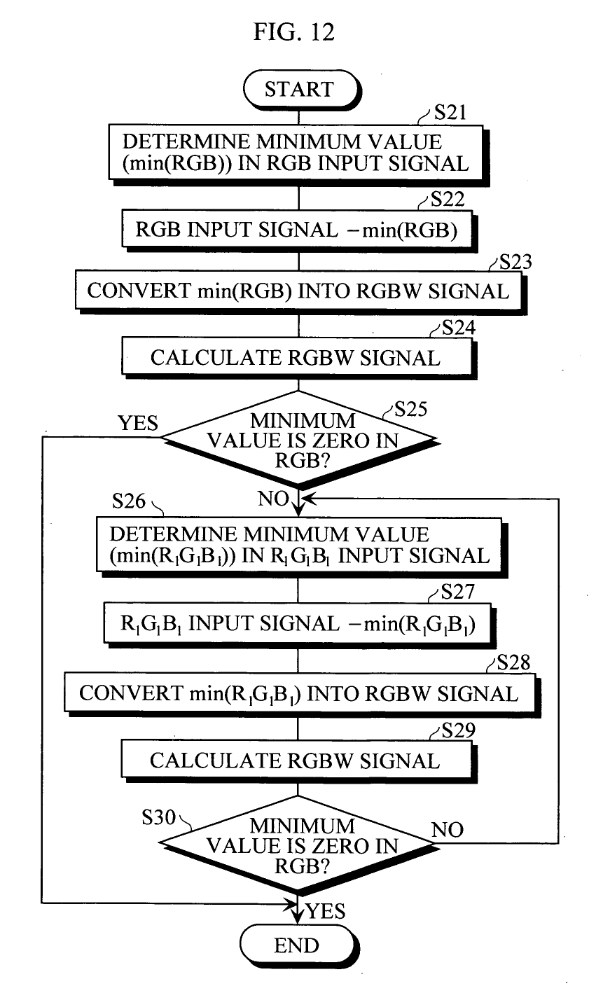

FIG. 12 shows the signal converting process for converting the RGB input signal into the RGBW signal.

It is assumed that the RGBW signal values for expressing the target white Wₜ(255) when all the RGB input signal values are 255 is the signal values shown in FIG. 6.

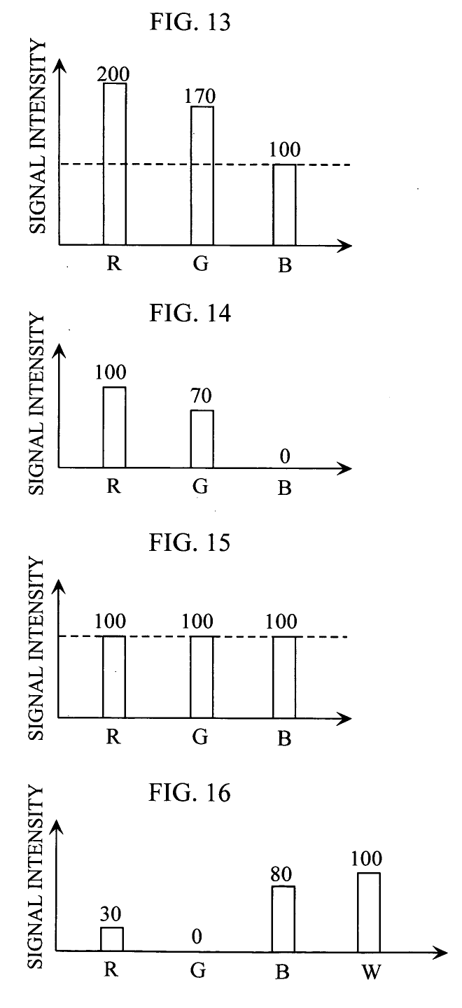

First, the minimum value min(RGB) is determined in the RGB input signals (step S21). As shown in FIG. 13, letting R=200, G=170, and B=100 in the RGB input signal values leads to min(RGB)=100 as shown in FIG. 15.

Then, the minimum value min(RGB) is subtracted from each RGB input signal (step S22). In the example of FIG. 13, as shown in FIG. 14, the subtraction results to RGB become 100, 70, and 0 respectively. Namely, the RGB input signal is divided into the RGB signal value of FIG. 14 and the RGB signal value of FIG. 15.

Then, the minimum value min(RGB) is converted into the RGBW signal using the RGBW signal value for expressing the target white Wₜ(255) when all the RGB input signal values are 255 (step S23). When the RGBW signal value for realizing the target white Wₜ(255) is the signal value shown in FIG. 6, in the example of FIG. 13, the RGBW signal value corresponding to the minimum value min(RGB) becomes shown in FIG. 16 (similar to FIG. 7).

Then, the RGBW signal corresponding to the RGB input signal is calculated by adding the RGBW signal value obtained in step S23 to the subtraction value (RGB−min(RGB)) obtained in step S22 (step S24). In the example of FIG. 13, the RGBW signal value corresponding to the RGB input signal becomes shown in FIG. 17.

R, G, B, and W of FIG. 17 are obtained by the following equation (5).
R=100+30=130
G=70+0=70
B=0+80=80
W=0+100=100 (5)

Then, it is determined whether the minimum value of the RBG signal in the obtained RGBW signal is zero or not (step S25). When the minimum value of the RBG signal in the obtained RGBW signal is zero, the signal converting process is ended. Namely, the RGBW signal obtained in step S24 becomes the RGBW output signal.

When the minimum value of the RBG signal in the obtained RGBW signal is not zero, the obtained RGBW signal is assumed to be the input RGBW signal, and the same processes (RGB-RGBW converting routine) from step S21 to step S24 are performed again.

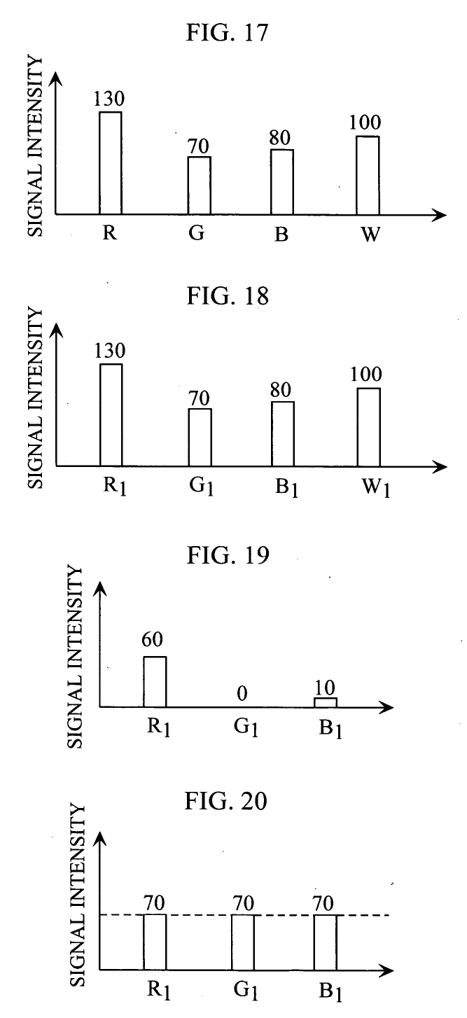

Namely, when the minimum value of the RBG signal in the obtained RGBW signal is not zero, the obtained RGBW signal is set at the R₁G₁B₁W₁ input signal as shown in FIG. 18. Then, the minimum value min(R₁G₁B₁) is determined in the R₁G₁B₁ input signal (step S26). Assuming that R=130, G=70, B=80, and W=100 in the R₁G₁B₁W₁ input signal as shown in FIG. 18, the minimum value min(R₁G₁B₁) becomes 70 as shown in FIG. 20.

Then, the minimum value min(R₁G₁B₁) is subtracted from each R₁G₁B₁ input signal (step S27). In the example of FIG. 18, as shown in FIG. 19, the subtraction results to RGB become 60, 0, and 10 respectively. Namely, the R₁G₁B₁ input signal is divided into the R₁G₁B₁ signal value of FIG. 19 and the R₁G₁B₁ signal value of FIG. 20.

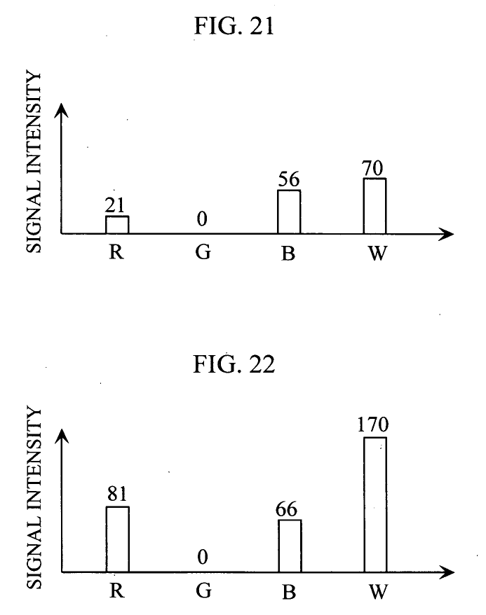

Then, the minimum value min(R₁G₁B₁) is converted into the RGBW signal using the RGBW signal value for expressing the target white Wₜ(255) when all the RGB input signal values are 255 (step S28). When the RGBW signal value for realizing the target white Wₜ(255) is the signal value shown in FIG. 6, in the example of FIG. 20, the RGBW signal value corresponding to the minimum value min(R₁G₁B₁) becomes shown in FIG. 21.

R, G, B, and W of FIG. 21 are obtained by the following equation (6).
R=77×70/255=21
G=0×70/255=0
B=204×70/255=56
W=255×70/255=70 (6)

Then, while the RGB signal is determined by adding the RGB signal value in the RGBW signal obtained in step S28 to the subtraction value (R₁G₁B₁−min(R₁G₁B₁)) obtained in step S27, the W signal is determined by adding the W signal value in the RGBW signal obtained in step S28 to W₁ in the R₁G₁B₁W₁ input signal (step S29). Thus, the RGBW signal is obtained.

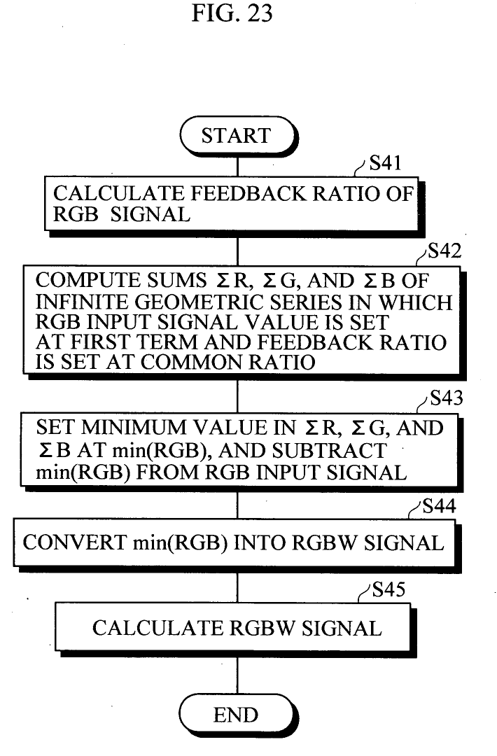

In the above example, the RGBW signal value becomes shown in FIG. 22. R, G, B, and W of FIG. 22 are obtained by the following equation (7).
R=60+21=81
G=0+0=0
B=10+56=66
W=100+70=170 (7)

Then, it is determined whether the minimum value of the RBG signal in the RGBW signal obtained in step S29 is zero or not (step S30). When the minimum value of the RBG signal in the obtained RGBW signal is zero, the signal converting process is ended.

When the minimum value of the RBG signal in the obtained RGBW signal is not zero, the flow returns to step S26. Namely, the RGB-RGBW converting routine is repeated until the minimum value of the RBG signal in the obtained RGBW signal becomes zero.

5. Second Modification of RGB-RGBW Signal Converting Process

As described in the first modification, sometimes the signal set to zero by subtracting the minimum value min(RGB) has a value not lower than 1 due to the subsequent conversion of the signal from the minimum value min(RGB) into the RGBW signal depending on the conditions. In this case, as described in the first modification, the RGB-RGBW converting routine is repeated.

The second modification proposes the signal converting method for obtaining the RGBW signal in which at least one of RGB signals becomes zero despite the conditions by performing the one-time RGB-RGBW converting routine.

Focusing on one signal in the RGB signal, the signal converting process will be described. It is assumed that the focused signal is always dealt with as the minimum value min(RGB) and the feedback of about 8% post-conversion W signal is obtained to the signal by converting the min(RGB) into the RGBW signal. For example, when an initial value is set at 50, the focused signal is changed according to the number of repetitions of the RGB-RGBW converting routine as shown in the following expression (8).
50→40→32→25.6→20.5→16.4→13.1→ . . . →0 (8)

In this case, the W signal becomes the value in which the entire numerical values of the expression (8) are added, and the W signal can be obtained as the sum of an infinite geometric series in which the first term is 50 and the common ratio is 0.8. In the case of −1 <common ratio<1, the sum of the infinite geometric series can be simplified as the following equation (9).
Sum of infinite geometric series=first term/(1−common ratio) (9)

Accordingly, when the infinite geometric series is expressed by the equation (8), the sum of the infinite geometric series becomes 50/(1−0.8)=250.

In the actual system, the sum of the infinite geometric series is calculated in each RGB signal, the minimum value in the calculated sums of the infinite geometric series is set at the minimum value min(RGB), and the RGB-RGBW converting routine is performed one time. As a result, one of the RGB signals becomes zero and the other two signals become the value not lower than zero in the obtained RGBW signals.

The case in which R=255, G=255, and B=50 in the RGB input signal values will be described as an example.

Assuming that the RGBW signal values for expressing the target white Wₜ(255) when all the RGB input signal values are 255 are the values shown in FIG. 6, a feedback ratio of the RGB signal becomes 0.3 (R of FIG. 6/W of FIG. 6=77/255), 0 (G of FIG. 6/W of FIG. 6), and 0.8 (B of FIG. 6/W of FIG. 6=204/255) by converting the minimum value min(RGB) into the RGBW signal.

When the sums of the infinite geometric series corresponding to R, G, and B are set ΣR, ΣG, and ΣB respectively, ΣR, ΣG, and ΣB are obtained as the following equation (10).
ΣR=255/(1−0.3)=364
ΣG=255/(1−0)=255
ΣB=50/(1−0.8)=250 (10)

Since the minimum value becomes 250, when 250 is subtracted from RGB, the subtraction results are obtained by the following equation (11).
R=255−250=5
G=255−250=5
B=50−250=−200 (11)

On the other hand, when the minimum value min(RGB) (=250) is converted into the RGBW signal, the results are obtained by the following equation (12).
R=250×0.3=75
G=250×0=0
B=250×0.8=200
W=250 (12)

Therefore, the RGBW output signal is obtained from the following equation (13).
R=5+75=80
G=5+0=5
B=−200+200=0
W=250 (13)

FIG. 23 shows the signal converting process for converting the RGB input signal into the RGBW signal.

The feedback ratio of the RGB signal is calculated using the RGBW signal values for expressing the target white Wₜ(255) when all the RGB input signal values are 255 (step S41). When the RGBW signal values for realizing the target white Wₜ(255) are the signal value shown in FIG. 6, the feedback ratio of the RGB signal becomes 0.3 (=77/255), 0, and 0.8 (=204/255).

Then, the sums of the infinite geometric series ΣR, ΣG, and ΣB are calculated in each RGB input signal. In the infinite geometric series, the RGB input signal value is set at the first term and the feedback ratio calculated in step S41 is set at the common ratio (step S42).

Then, the minimum value is set at min(RGB) in the sums of the infinite geometric series ΣR, ΣG, and ΣB calculated in each RGB input signal, and the minimum value is subtracted from the RGB input signal (step S43).

The minimum value min(RGB) is converted into the RGBW signal using the RGBW signal value for expressing the target white Wₜ(255) when all the RGB input signal values are 255 (step S44).

Then, the RGBW signal corresponding to the RGB input signal is calculated by adding the RGBW signal value determined in step S44 to the subtraction value (RGB−min(RGB)) calculated in step S43 (step S45).

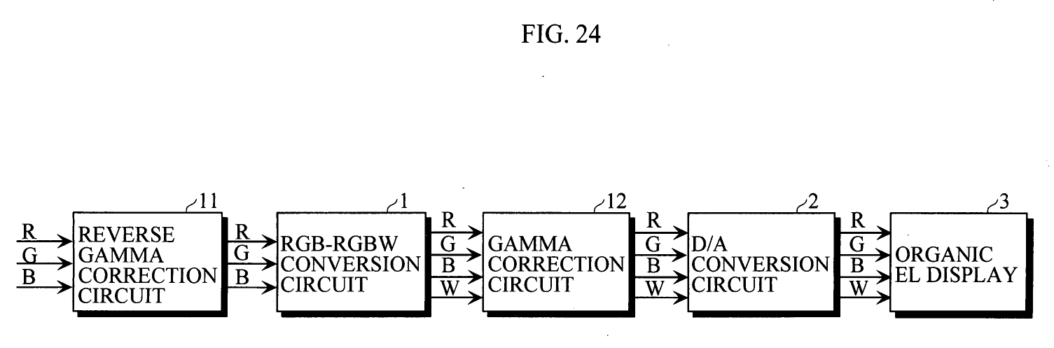

In the RGB input signal, sometimes the gamma correction is previously performed. In this case, in order to simplify the signal processing, it is preferable that the pre-gamma correction RGB signal is inputted to the RGB-RGBW conversion circuit 1 of FIG. 2. Therefore, as shown in FIG. 24, it is preferable that a gamma correction circuit 12 is arranged at a post-stage of the RGB-RGBW conversion circuit 1 while a reverse gamma correction circuit 11 is arranged at a pre-stage of the RGB-RGBW conversion circuit 1. The reverse gamma correction circuit 11 performs the reverse gamma correction to the RGB input signal to which the gamma correction is previously performed. The gamma correction circuit 12 performs the gamma correction to the RGBW signal, outputted from the RGB-RGBW conversion circuit 1, according to panel properties of the organic EL display 3. Accordingly, the calculating methods cited in the first embodiment, the first modification, and the second modification can directly be used for various computations in the RGB-RGBW conversion circuit 1. Namely, the RGB signal outputted from the reverse gamma correction circuit 11 is used as “RGB input signal” in the first embodiment, the first modification, and the second modification

### Second Embodiment

(B) RGB-RGBX (X is an Arbitrary Color) Signal

The process for converting the RGB signal into the RGBW signal is described in the item (A). In the second embodiment, setting X to be an arbitrary color except for RGB (arbitrary color having a chromaticity coordinate different from those in RGB), the process for converting the RGB signal into the RGBX signal will be described.

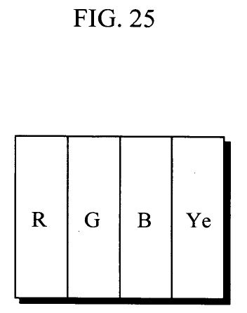

The second embodiment in which X is set at Ye will be described below. In the self-luminous type display, as shown in FIG. 25, one pixel includes four unit pixels, and the color filters for displaying the three primary colors, such as R (Red), G (Green), and B (Blue) are arranged in three of the four unit pixels. The color filter for displaying Ye (Yellow) is arranged in the remaining one unit pixel.

1. Configuration of Display Device

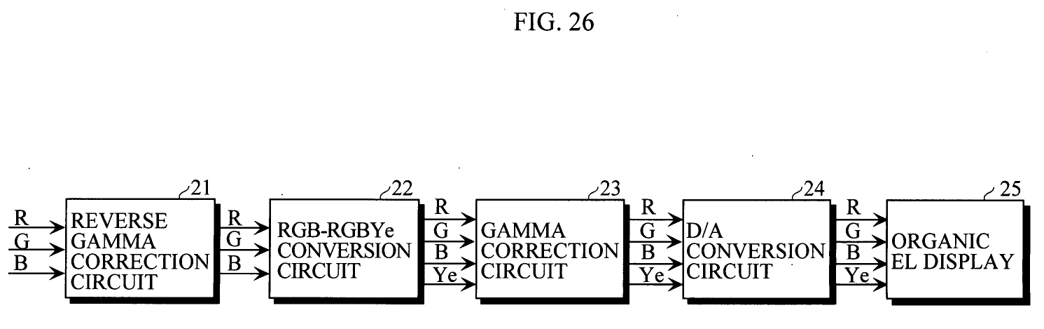

FIG. 26 shows the configuration of the display device.

It is assumed that the gamma correction is previously performed to the digital RGB input signal. The digital RGB input signal to which the gamma correction is previously performed is inputted to a reverse gamma correction circuit 21. The reverse gamma correction circuit 21 converts the RGB input signal into the pre-gamma correction RGB signal by performing the reverse gamma correction to the RGB input signal.

The RGB signal obtained by the reverse gamma correction circuit 21 is transmitted to an RGB-RGBYe signal conversion circuit 22. The RGB-RGBYe signal conversion circuit 22 converts the RGB input signal into the RGBYe signal. The RGBYe signal obtained by the RGB-RGBYe signal conversion circuit 22 is transmitted to a gamma correction circuit 23.

The gamma correction circuit 23 performs the gamma correction to the inputted RGBYe signal according to the panel properties of an organic EL display 25. A D/A conversion circuit 24 converts the RGBYe signal obtained by the gamma correction circuit 23 into the analog RGBYe signal. The RGBYe signal obtained by the D/A conversion circuit 24 is transmitted to the organic EL display 25 in which one pixel includes four unit pixels of RGBYe.

The RGB-RGBYe signal conversion circuit 22 converts the RGB signal into the RGBYe signal based on the RGB signal for realizing the chromaticity and the maximum brightness of Ye (yellow determined by the corresponding color filter). Therefore, first, the RGB signal value calculating method for realizing the chromaticity and the maximum brightness of Ye will be described.

2. RGB Signal Value Calculating Method for Realizing Chromaticity and Maximum Brightness of Ye

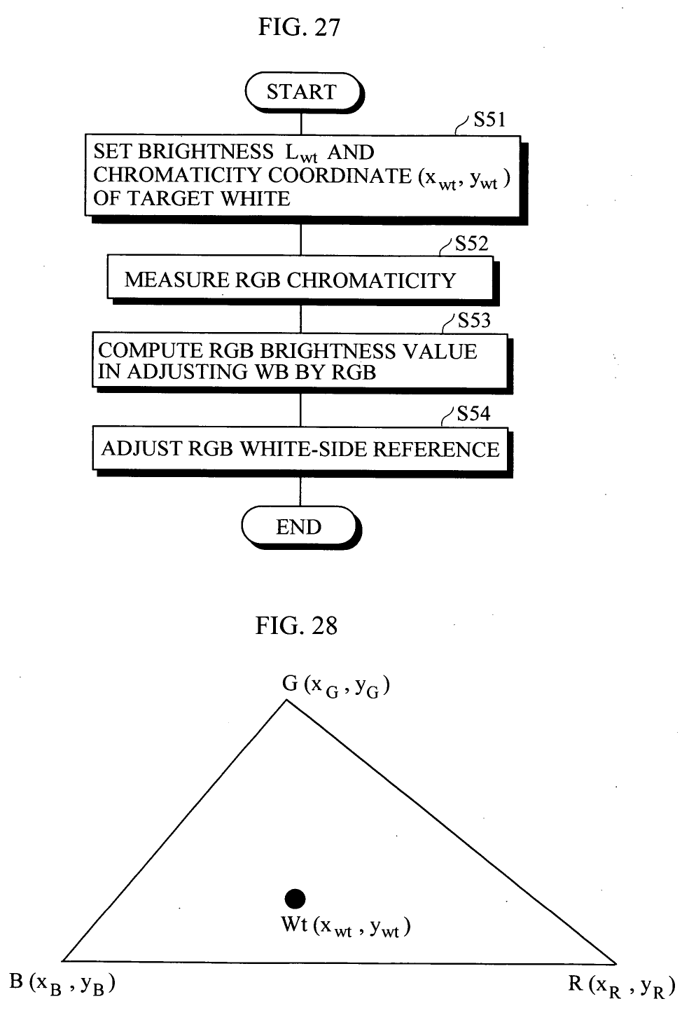

FIG. 27 shows an RGB reference adjusting process.

The brightness L_{Wt} and the chromaticity coordinate (x_{Wt}, y_{Wt}) of the target white Wₜ are set (step S51).

Then, the RGB chromaticity is measured in the organic EL display 25 (step S52). For example, when the R chromaticity is measured, only the R display unit pixel in the organic EL display 25 is light-emitted and the chromaticity of the R display unit pixel is measured with the optical measurement system. The measured RGB chromaticity coordinates are set at (x_{R}, y_{R}), (x_{G}, y_{G}), and (x_{B}, y_{B}) respectively. FIG. 28 shows the chromaticity coordinates of RGB and the target white Wt.

Then, the RGB brightness value in adjusting white balance (WB) by RGB is calculated (step S53). Namely, the RGB brightness values L_{WR}, L_{WG}, and L_{WB} in expressing the brightness L_{Wt} and the chromaticity (x_{Wt}, y_{Wt}) of the target white Wₜ are calculated by the three colors of RGB. The brightness values L_{WR}, L_{WG}, and L_{WB} are obtained by the following equation (14).

$$( \begin{matrix}\frac{{x}_{R}}{{y}_{R}} & \frac{{x}_{G}}{{y}_{G}} & \frac{{x}_{B}}{{y}_{B}} \\ 1.0 & 1.0 & 1.0 \\ \frac{{z}_{R}}{{y}_{R}} & \frac{{z}_{G}}{{y}_{G}} & \frac{{z}_{B}}{{y}_{B}}\end{matrix} ) ( \begin{matrix}L {w}_{R} \\ L {w}_{G} \\ L {w}_{B}\end{matrix} ) = ( \begin{matrix}\frac{{x}_{wt}}{{y}_{wt}} {L}_{wt} \\ {L}_{wt} \\ \frac{{z}_{wt}}{{y}_{wt}} {L}_{wt}\end{matrix} ) \qquad ( 14 )$$

Herein, z_{R}=1−x_{R}−y_{R}, z_{G}=1−x_{G}−y_{G}, z_{B}=1−x_{B}−y_{B}, and z_{Wt}=1−x_{Wt}−y_{Wt}.

Then, the RGB white-side reference brightness is calculated using the calculation result of step S53 (step S54).

In the case where the RGB input signal value is expressed in terms of eight bits, the RGB white-side reference brightness is adjusted so that the light-emission brightness and the light-emission color become the brightness L_{Wt} and the chromaticity (x_{Wt}, y_{Wt}) of the target white Wₜ when (255, 255, 255) is inputted as the RGB signal to the RGB-RGBYe conversion circuit 22. Namely, the RGB white-side reference brightness is adjusted so that the RGB brightness values become the brightness values L_{WR}, L_{WG}, and L_{WB} calculated in step S53 respectively when (255, 255, 255) is inputted as the RGB signal to the RGB signal to the RGB-RGBYe conversion circuit 22.

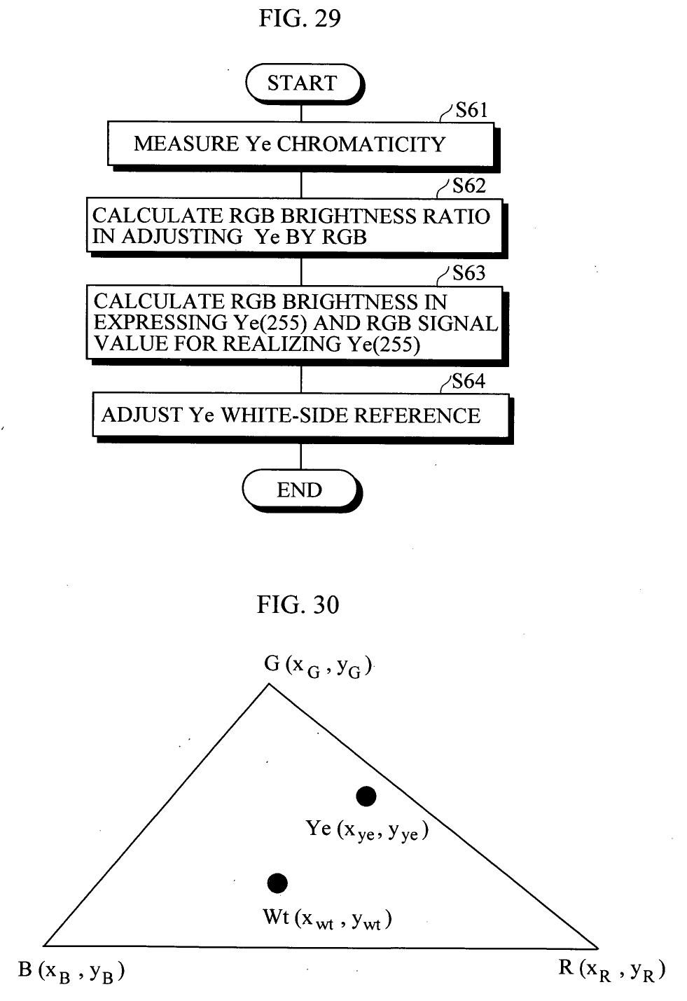

FIG. 29 shows a Ye reference adjusting process.

The Ye chromaticity is measured in the organic EL display 25 (step S61). Namely, only the Ye display unit pixel in the organic EL display 25 is light-emitted and the chromaticity of the Ye display unit pixel is measured with the optical measurement system. The measured Ye chromaticity coordinate is set at (x_{ye}, y_{ye}). FIG. 30 shows the chromaticity coordinates of RGB, the target white Wt, and Ye.

Then, the RGB brightness ratio in adjusting Ye by RGB is calculated (step S62). Namely, the RGB brightness ratios L_{yeR}, L_{yeG}) and L_{yeB} in expressing the Ye chromaticity (x_{ye}, y_{ye}) are calculated by the three colors of RGB. The RGB brightness ratios L_{yeR}, L_{yeG}, and L_{yeB} are obtained by the following equation (15).

$$( \begin{matrix}\frac{{x}_{R}}{{y}_{R}} & \frac{{x}_{G}}{{y}_{G}} & \frac{{x}_{B}}{{y}_{B}} \\ 1.0 & 1.0 & 1.0 \\ \frac{{z}_{R}}{{y}_{R}} & \frac{{z}_{G}}{{y}_{G}} & \frac{{z}_{B}}{{y}_{B}}\end{matrix} ) ( \begin{matrix}{Lye}_{R} \\ {Lye}_{G} \\ {Lye}_{B}\end{matrix} ) = ( \begin{matrix}\frac{{x}_{ye}}{{y}_{ye}} \\ 1 \\ \frac{{z}_{ye}}{{y}_{ye}}\end{matrix} ) \qquad ( 15 )$$

Herein, z_{R}=1−x_{R}−y_{R}, z_{G}=1−x_{G}−y_{G}, z_{B}=1−x_{B}, y_{B}, and z_{ye}=1−x_{ye}−y_{ye}.

Then, the RGB signal value (RGB signal value equivalent to Ye(255)) for realizing the chromaticity and the maximum brightness of Ye is determined while the RGB brightness in expressing the chromaticity and the maximum brightness of Ye is calculated, based on the RGB brightness values L_{WR}, L_{WG}, and L_{WB}, determined in step S53 of FIG. 27, in adjusting the white balance (WB) by RGB and the RGB brightness ratios L_{yeR}, L_{yeG}, and L_{yeB}, determined in step S62, in adjusting Ye by RGB (step S63).

Namely, the RGB brightness values L_{yeR}′, L_{yeG}′, and L_{yeB}′ for expressing Ye(255) are calculated within the range of RGB brightness determined in expressing the target white Wₜ.

L_{WR}/L_{yeR}, L_{WG}/L_{yeG} and L_{WB}/L_{yeB} are calculated, and L_{yeR}, L_{yeG}, and L_{yeB} are multiplied by the minimum value of the L_{WR}/L_{yeR}, L_{WG}/L_{yeG}, and L_{WB}/L_{yeB} respectively, which results in the RGB brightness values L_{yeR}′, L_{yeG}′, and L_{yeB}′ for expressing Ye(255).

For example, the RGB brightness values L_{WR}, L_{WG}, and L_{WB} are set at 30 (cd), 60 (cd), and 10 (cd) in adjusting the white balance (WB) respectively and the RGB brightness ratio L_{yeR}:L_{yeG}:L_{yeB} is set at 0.25:0.6:0.05 in adjusting Ye, obtaining L_{WR}/L_{yeR}=120, L_{WG}/L_{yeG}=100, and L_{WB}/L_{yeB}=200. Since the minimum value is 100, when L_{yeR}′, L_{yeG}′, and L_{yeB}′ are multiplied by 100, the RGB brightness values L_{yeR}′, L_{yeG}′, and L_{yeB}′ for expressing the chromaticity and the maximum brightness of Ye become 25 (cd), 60 (cd), and 5 (cd) respectively.

Assuming that the RGB brightness for expressing the chromaticity and the maximum brightness of Ye is (L_{yeR}′, L_{yeG}′, L_{yeB}′) and the RGB brightness value is (L_{WR}, L_{WG}, L_{WB}) in adjusting the white balance (WB), the RGB signal value (R_{ye}, G_{ye}, B_{ye}) for realizing the chromaticity and the maximum brightness of Ye becomes R_{ye}=255×L_{yeR}′/L_{WR}, G_{ye}=255×L_{yeG}′/L_{WG}, and B_{ye}=255×L_{yeB}′/L_{WB}.

In the above example, R_{ye}=255×25/30=213, G_{ye}=255×60/60=255, and B_{ye}=255×5/10=128 are obtained respectively.

Then, the Ye white-side reference is adjusted based on the RGB brightness values L_{yeR}′, L_{yeG}′, and L_{yeB}′, obtained in step S63, for expressing the chromaticity and the maximum brightness of Ye (step S64). The Ye white-side reference voltage (output voltage of D/A conversion circuit 24 corresponding to Ye=255) is adjusted so that the brightness of the Ye white-side reference becomes the total value (L_{yeR}′+L_{yeG}′+L_{yeB}′) of the RGB brightness values for expressing the chromaticity and the maximum brightness of Ye when only Ye is displayed.

3. RGB-RGBYe Signal Converting Process by RGB-RGBYe Signal Conversion Circuit 22

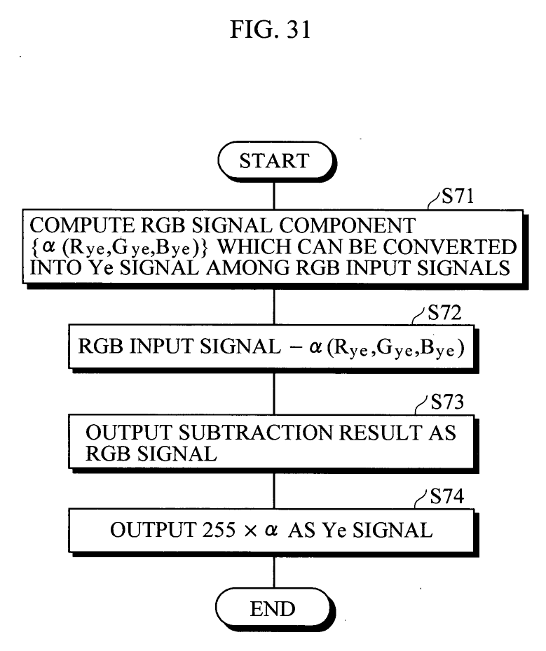

FIG. 31 shows the RGB-RGBYe signal converting process performed by the RGB-RGBYe signal conversion circuit 22.

In this case, the input signal to the RGB-RGBYe signal conversion circuit 22 is referred to as RGB input signal. An RGB signal component is calculated so that at least one of the RGB subtraction results becomes zero, when the RGB signal component is subtracted from the RGB input signal. The RGB signal component can be converted into the Ye signal in the RGB input signal (step S71).

Assuming that the RGB signal values for realizing the chromaticity and the maximum brightness of Ye are R_{ye}, G_{ye}, and B_{ye}, the RGB signal components converted into the Ye signal are expressed by α(R_{ye}, G_{ye}, B_{ye}). Therefore, first, α(R_{ye}, G_{ye}, B_{ye}) is obtained so that at least one of the RGB subtraction results becomes zero when a is subtracted from the RGB input signal. Specifically, the RGB input signal expressed in terms of R, G, and B. The minimum value of R/R_{ye}, G/G_{ye}, and B/B_{ye} is set at α, and then α(R_{ye}, G_{ye}, B_{ye}) is calculated.

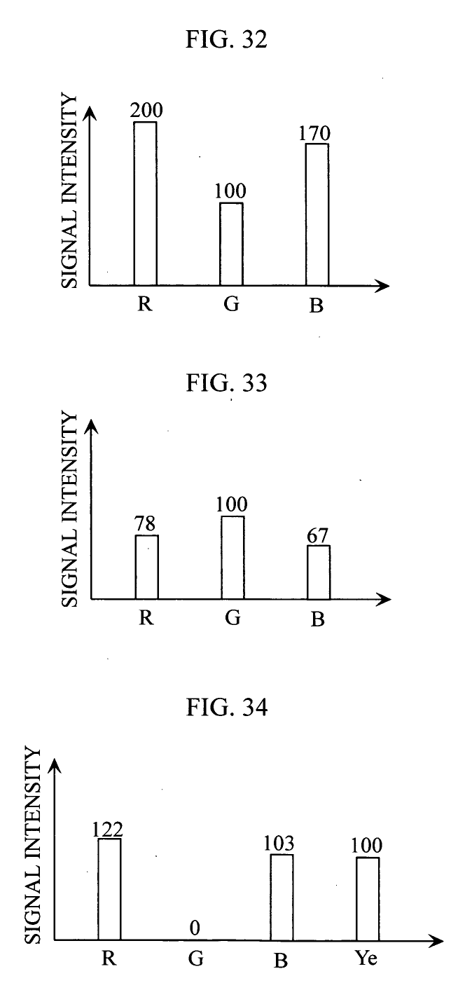

For example, it is assumed that the RGB input signal has the signal intensity as shown in FIG. 32. When the RGB maximum signal value (R_{ye}, G_{ye}, B_{ye}) for realizing the chromaticity and the maximum brightness of Ye becomes R_{ye}=213, G_{ye}=255, and B_{ye}=128, then R=200, G=100, and B=170 in the RGB input signal, obtaining R/R_{ye}=200/213=0.95, G/G_{ye}=100/255=0.39, and B/B_{ye}=170/128=1.33. As a result, the minimum value becomes 0.39. Therefore, letting α=0.39 leads to αR_{ye}=78, αG_{ye}=100, and αB_{ye}=67. Namely, the RGB signal component α(R_{ye}, G_{ye}, B_{ye}) converted into the Ye signal is obtained as shown in FIG. 33.

Then, the RGB signal component α(R_{ye}, G_{ye}, B_{ye}) converted into the Ye signal is subtracted from the RGB input signal (step S72).

In the above example, the R subtraction result becomes 122 (=200−78), the G subtraction result becomes 0 (=100−100), and the B subtraction result becomes 103 (=170−67).

Each of the RGB subtraction results calculated in step S72 is outputted as the RGB signal (step S73).

255×α is also outputted as the Ye signal (step S74). In the above example, the Ye signal becomes 100 (=0.39×255). That is, in the above example, the RGBYe signal becomes as shown in FIG. 34.

In the second embodiment, the RGB signal is converted into the RGBYe signal. However, the technique described in the second embodiment can also be applied to the case, in which X is set at an arbitrary color except for RGB and the RGB signal is converted into the RGBX signal.

### Third Embodiment

1. Configuration of Display Device

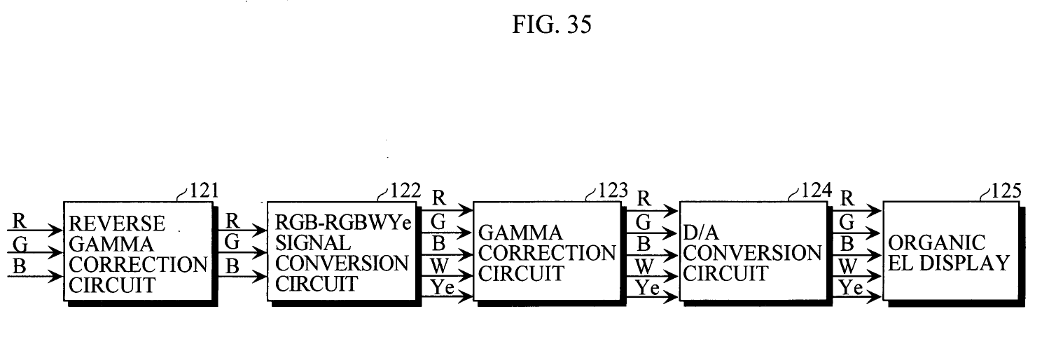

FIG. 35 shows a configuration of a display device.

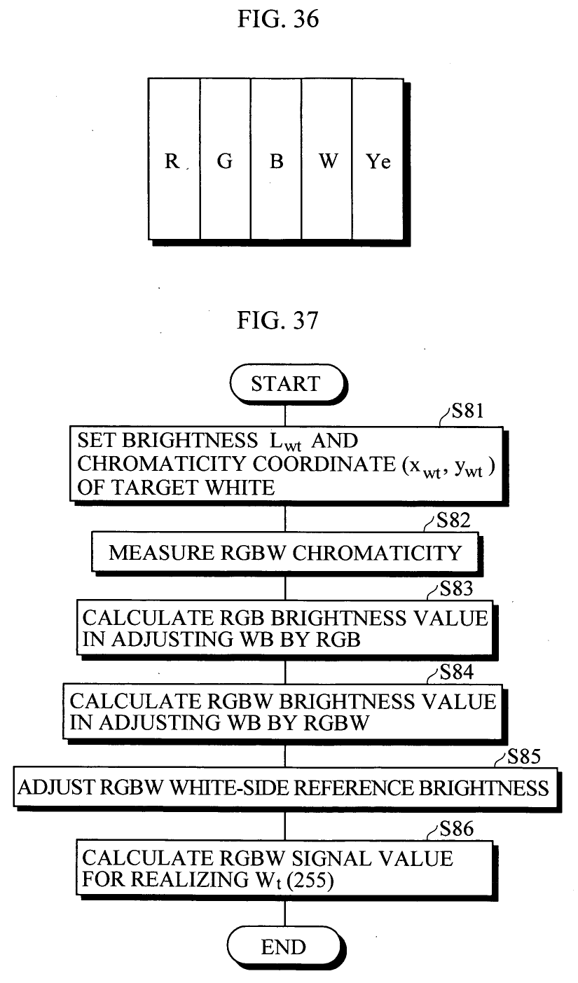

An organic EL display 125, in which the color filters are affixed to the self-luminous material, is used. In the organic EL display 125, as shown in FIG. 36, one pixel includes five unit pixels, and the color filters for displaying the three primary colors such as R (Red), G (Green), and B (Blue) are arranged in three of the five unit pixels. The W (White) display dedicated unit pixel in which the color filter is not arranged is formed in one of the remaining two unit pixels, and the color filter for displaying an arbitrary color except for RGB (Ye (Yellow) in this case) is arranged in the other unit pixel.

In the RGBWX array, since the white display dedicated unit pixel has no color filter, the light usable efficiency (light-emission efficiency) is extremely high. Therefore, in order to display 100% white, when the display is performed not by the light emission of the RGB display unit pixels, but by the light emission of the white display dedicated unit pixel, electrical power consumption is largely reduced. However, actually the white chromaticity obtained by the self-luminous type display does not frequently reach the target white chromaticity, so that it is necessary that the light emission of the RGB display unit pixels is added to the light emission of the white display dedicated unit pixel. It is assumed that the yellow display dedicated unit pixel has the second highest light-emission efficiency while the white display dedicated unit pixel has the highest light-emission efficiency.

It is assumed that the gamma correction is previously performed to the digital RGB input signal inputted to the display device. The digital RGB input signal to which the gamma correction is previously performed is inputted to a reverse gamma correction circuit 121. The reverse gamma correction circuit 121 converts the RGB input signal into the pre-gamma correction RGB signal by performing the reverse gamma correction to the RGB input signal.

The RGB signal obtained by the reverse gamma correction circuit 121 is transmitted to an RGB-RGBWYe signal conversion circuit 122. The RGB-RGBWYe signal conversion circuit 122 converts the RGB input signal into the RGBWYe signal. The RGBYe signal obtained by the RGB-RGBWYe signal conversion circuit 122 is transmitted to a gamma correction circuit 123.

The gamma correction circuit 123 performs the gamma correction to the inputted RGBWYe signal according to the panel properties of the organic EL display 125. A D/A conversion circuit 124 converts the RGBWYe signal obtained by the gamma correction circuit 123 into the analog RGBWYe signal. The RGBWYe signal obtained by the D/A conversion circuit 124 is transmitted to the organic EL display 125 in which one pixel includes five unit pixels of RGBWYe.

2. Reference Adjustment

The reference adjustment includes the RGBW white-side reference adjustment and the Ye white-side reference adjustment.

FIG. 37 shows the RGBW white-side reference adjusting process.

The brightness L_{Wt} and the chromaticity coordinate (x_{Wt}, y_{Wt}) of the target white Wₜ are set (step S81).

Then, the RGBW chromaticity is measured in the organic EL display 125 (step S82). For example, when the R chromaticity is measured, only the R display unit pixel in the organic EL display 125 is light-emitted and the chromaticity of the R display unit pixel is measured with the optical measurement system. The measured RGBW chromaticity coordinates are set at (x_{R}, y_{R}), (x_{G}, y_{G}), (x_{B}, y_{B}), and (x_{W}, y_{W}) respectively.

Then, the RGB brightness value in adjusting the white balance (WB) by RGB is calculated (step S83). Namely, the RGB brightness values L_{WR1}, L_{WG1}, and L_{WB1} in expressing the brightness L_{Wt} and the chromaticity (x_{Wt}, y_{Wt}) of the target white Wₜ are calculated by the three colors of RGB. The RGB brightness values L_{WR1}, L_{WG1}, and L_{WB1} are obtained by the following equation (16).

$$( \begin{matrix}\frac{{x}_{R}}{{y}_{R}} & \frac{{x}_{G}}{{y}_{G}} & \frac{{x}_{B}}{{y}_{B}} \\ 1.0 & 1.0 & 1.0 \\ \frac{{z}_{R}}{{y}_{R}} & \frac{{z}_{G}}{{y}_{G}} & \frac{{z}_{B}}{{y}_{B}}\end{matrix} ) ( \begin{matrix}{Lw}_{R 1} \\ {Lw}_{G 1} \\ {Lw}_{B 1}\end{matrix} ) = ( \begin{matrix}\frac{{x}_{wt}}{{y}_{wt}} {L}_{wt} \\ {L}_{wt} \\ \frac{{z}_{wt}}{{y}_{wt}} {L}_{wt}\end{matrix} ) \qquad ( 16 )$$

Herein, z_{R}=1−x_{R}−y_{R}, z_{G}=1−x_{G}−y_{G}, z_{B}=1−x_{B}−y_{B}, and z_{Wt}=1−x_{Wt}−y_{Wt}.

Then, the RGBW brightness value in adjusting the white balance (WB) by RGBW is calculated (step S84). Namely, the RGBW brightness values L_{WR2}, L_{WG2}, L_{WB2}, and L_{W2} in expressing the brightness L_{Wt} and the chromaticity (x_{Wt}, y_{Wt}) of the target white Wₜ are calculated by the four colors of RGBW.

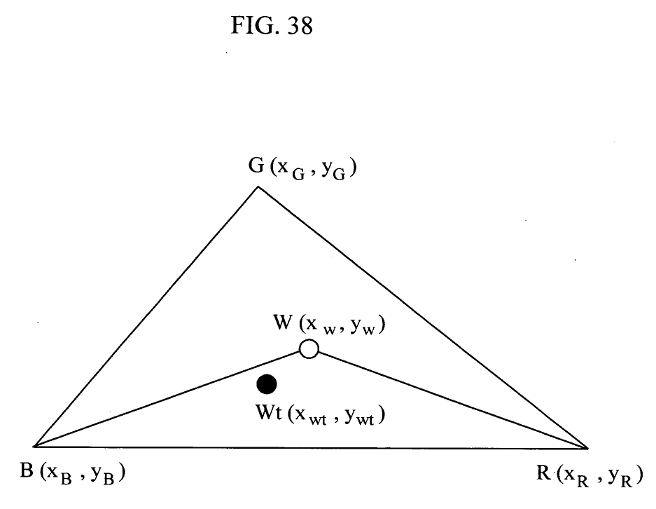

Assuming that there is a relationship shown in FIG. 38 between the RGBW chromaticity coordinate (x_{R}, y_{R}), (x_{G}, y_{G}), (x_{B}, y_{B}), and (x_{W}, y_{W}) and the chromaticity coordinate (x_{Wt}, y_{Wt}) of the target white Wₜ, the chromaticity of the target white Wₜ can be expressed only by the three colors of RBW. The RBW brightness values L_{WR2}, L_{WB2}, and L_{W2} in expressing the brightness L_{Wt} and chromaticity (x_{Wt}, y_{Wt}) of the target white Wₜ are obtained from the following equation (17) by the three colors of RBW. In this case, the G brightness value L_{WG2} becomes zero.

$$( \begin{matrix}\frac{{x}_{R}}{{y}_{R}} & \frac{{x}_{w}}{{y}_{w}} & \frac{{x}_{B}}{{y}_{B}} \\ 1.0 & 1.0 & 1.0 \\ \frac{{z}_{R}}{{y}_{R}} & \frac{{z}_{w}}{{y}_{w}} & \frac{{z}_{B}}{{y}_{B}}\end{matrix} ) ( \begin{matrix}{L}_{wR 2} \\ {L}_{w 2} \\ {L}_{wB 2}\end{matrix} ) = ( \begin{matrix}\frac{{x}_{wt}}{{y}_{wt}} {L}_{wt} \\ {L}_{wt} \\ \frac{{z}_{wt}}{{y}_{wt}} {L}_{wt}\end{matrix} ) \qquad ( 17 )$$

Herein, z_{R}=1−x_{R}−y_{R}, z_{W}=1−x_{W}−y_{W}, z_{B}=1−x_{B}−y_{B} and z_{Wt}=1−x_{Wt}−y_{Wt}.

Then, the RGBW white-side reference brightness is adjusted using the calculation result of step S83 (step S85).

In the following description, the RGB input signal should mean the RGB signal obtained by the reverse gamma correction circuit 121, i.e. the RGB signal inputted to the RGB-RGBWYe signal conversion circuit 122. In the case where the RGB input signal value is expressed in terms of eight bits, the RGB white-side reference brightness is adjusted so that the light-emission brightness and the light-emission color become the brightness L_{Wt} and chromaticity (x_{Wt}, y_{Wt}) of the target white Wₜ when (255, 255, 255) is inputted as the RGB signal to the RGB-RGBWYe signal conversion circuit 122.

Namely, the RGB white-side reference brightness is adjusted so that the RGB brightness values become the brightness values L_{WR1}, L_{WG1}, and L_{WB1} calculated in step S83 respectively when (255, 255, 255) is inputted as the RGB signal to the RGB-RGBWYe signal conversion circuit 122. Thus, when the RGB white-side reference brightness is adjusted, the light-emission color always becomes the chromaticity of the target white in the case where the RGB input signals have the same value. The W white-side reference brightness is adjusted so as to become the target brightness (the W brightness value L_{W2} determined in step S84 of FIG. 37) when only W is displayed.

The RGBW signal value for realizing the target white Wₜ(255) when all the RGB input signal values are 255 is calculated (step S86). It is assumed that the RGBW signal value for realizing the target white Wₜ(255) when all the RGB input signal values are 255 is set at (R_{W}, G_{W}, B_{W}, W_{W}). Assuming that the RGB brightness values, calculated in step S83, for realizing the brightness and the chromaticity of the target white are set at L_{WR1}, L_{WG1}, and L_{WB1} and the RGBW brightness values, calculated in step S84, for realizing the brightness and the chromaticity of the target white are set at L_{WR2}, L_{WG2}, L_{WB2}, and L_{W2}, the RGBW signal value for realizing the target white when all the RGB input signal values are 255 is calculated based on the following equation (18).
R_{W}=255×L_{WR2}/L_{WR1}
G_{W}=255×L_{WG2}/L_{WG1}
B_{W}=255×L_{WB2}/L_{WB1}
W_{W}=255 (18)

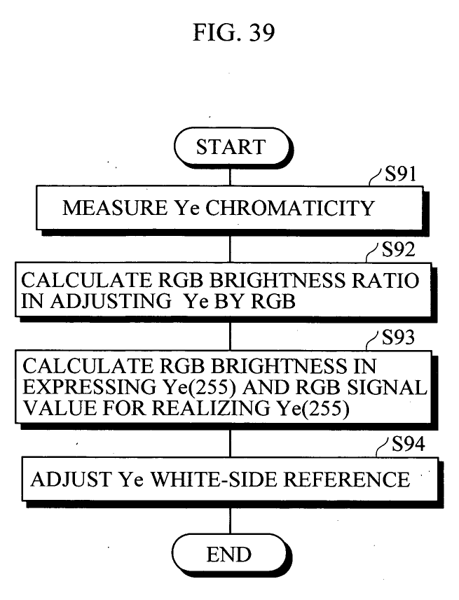

FIG. 39 shows a Ye reference adjusting process.

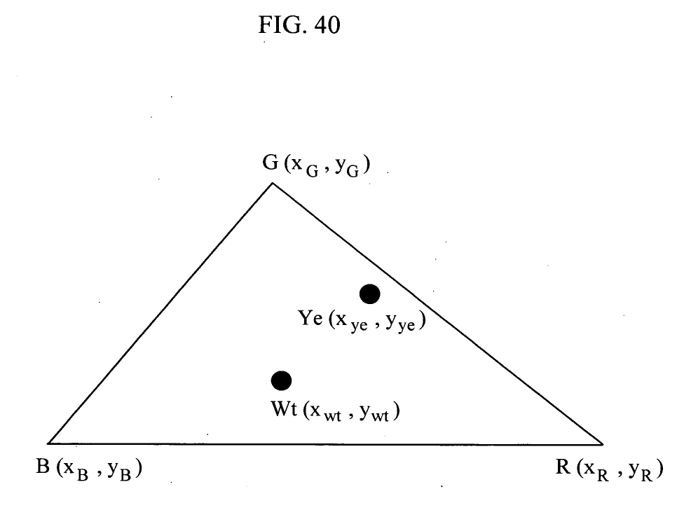

The Ye chromaticity of the organic EL display 125 is measured (step S91). Namely, only the Ye display unit pixel in the organic EL display 125 is light-emitted and the chromaticity of the Ye display unit pixel is measured with the optical measurement system. The measured Ye chromaticity coordinate is set at (x_{ye}, y_{ye}). FIG. 40 shows the chromaticity coordinates of RGB, the target white Wt, and Ye.

Then, the RGB brightness ratio in adjusting Ye by RGB is calculated (step S92). Namely, the RGB brightness ratios L_{yeR}, L_{yeG}, and L_{yeB} in expressing the Ye chromaticity (x_{ye}, y_{ye}) are calculated by the three colors of RGB. The RGB brightness ratios L_{yeR}, L_{yeG}, and L_{yeB} are obtained by the following equation (19).

$$( \begin{matrix}\frac{{x}_{R}}{{y}_{R}} & \frac{{x}_{G}}{{y}_{G}} & \frac{{x}_{B}}{{y}_{B}} \\ 1.0 & 1.0 & 1.0 \\ \frac{{z}_{R}}{{y}_{R}} & \frac{{z}_{G}}{{y}_{G}} & \frac{{z}_{B}}{{y}_{B}}\end{matrix} ) ( \begin{matrix}{Lye}_{R} \\ {Lye}_{G} \\ {Lye}_{B}\end{matrix} ) = ( \begin{matrix}\frac{{x}_{ye}}{{y}_{ye}} \\ 1 \\ \frac{{z}_{ye}}{{y}_{ye}}\end{matrix} ) \qquad ( 19 )$$

Herein, z_{R}=1−x_{R}−y_{R}, z_{G}=1−x_{G}−y_{G}, z_{B}=1−x_{B}−y_{B}, and z_{ye}=1−x_{ye}−y_{ye}.

Then, the RGB signal value (RGB signal value for realizing Ye(255)) for realizing the chromaticity and the maximum brightness of Ye is determined while the RGB brightness in expressing the chromaticity and the maximum brightness of Ye is calculated, based on the RGB brightness values L_{WR1}, L_{WG1}, and L_{WB1}, determined in step S83 of FIG. 37, in adjusting the white balance (WB) by RGB and the RGB brightness ratios L_{yeR}, L_{yeG}, and L_{yeB}, in adjusting Ye by RGB (step S93).

Namely, the RGB brightness values L_{yeR}′, L_{yeG}′, and L_{yeB}′ for expressing Ye(255) are calculated within the RGB brightness range determined in expressing the target white Wₜ.

L_{WR1}/L_{yeR}, L_{WG1}/L_{yeG}, and L_{WB1}/L_{yeB} are calculated, and L_{yeR}, L_{yeG}, and L_{yeB} are multiplied by the minimum value of the L_{WR1}/L_{yeR}, L_{WG1}/L_{yeG}, and L_{WB1}/L_{yeB} respectively, which results in the RGB brightness values L_{yeR}′, L_{yeG}′, and L_{yeB}′ for expressing Ye(255).

For example, the RGB brightness values L_{WR1}, L_{WG1}, and L_{WB1} are set at 30 (cd), 60 (cd), and 10 (cd) in adjusting the white balance (WB) respectively, and the RGB brightness ratio L_{yeR}:L_{yeG}:L_{yeB} is set at 0.25:0.6:0.05 in adjusting Ye, obtaining L_{WR1}/L_{yeR}=120, L_{WG1}/L_{yeG}=100, and L_{WB1}/L_{yeB}=200. Since the minimum value is 100, when L_{yeR}, L_{yeG}, and L_{yeB} are multiplied by 100, the RGB brightness values L_{yeR}′, L_{yeG}′, and L_{yeB}′ for expressing Ye(255) become 25 (cd), 60 (cd), and 5 (cd) respectively.

Assuming that the RGB brightness for expressing Ye(255) is (L_{yeR}′, L_{yeG}′, L_{yeB}′) and the RGB brightness value is (L_{WR1}, L_{WG1}, L_{WB1}) in adjusting the white balance (WB), the RGB signal value (R_{ye}, G_{ye}, B_{ye}) for realizing Ye(255) becomes R_{ye}=255×L_{yeR}′/L_{WR1}, G_{ye}=255×L_{yeG}′/L_{WG1}, and B_{ye}=255×L_{yeB}′/L_{WB1} respectively.

In the above example, R_{ye}=255×25/30=213, G_{ye}=255×60/60=255, and B_{ye}=255×5/10=128 are obtained respectively.

Then, the Ye white-side reference is adjusted based on the RGB brightness values L_{yeR}′, L_{yeG}′, and L_{yeB}′, obtained step S93, for expressing Ye(255) (step S94). The Ye white-side reference voltage (output voltage of D/A conversion circuit 124 corresponding to Ye=255) is adjusted so that the brightness of the Ye white-side reference becomes the total value (L_{yeR}′+L_{yeG}′+L_{yeB}′) of the RGB brightness values for expressing the chromaticity and the maximum brightness of Ye when only Ye is displayed.

3. RGB-RGBWYe Signal Conversion Circuit 122

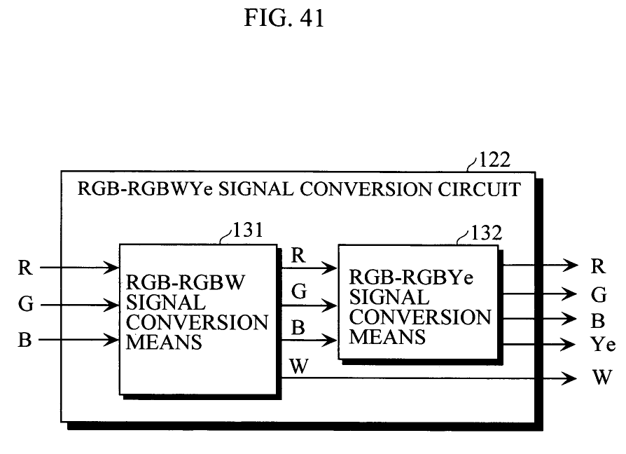

FIG. 41 shows a functional configuration of the RGB-RGBWYe signal conversion circuit 122.

The RGB-RGBWYe signal conversion circuit 122 includes RGB-RGBW signal conversion means 131 and RGB-RGBYe signal conversion means 132. The RGB-RGBW signal conversion means 131 converts the RGB signal obtained by the reverse gamma correction circuit 121 into the RGBW signal. The RGB-RGBYe signal conversion means 132 converts the RGB signal in the RGBW signal obtained by the RGB-RGBW signal conversion means 131 into the RGBYe signal.

4. RGB-RGBW Signal Conversion Means 131

4-1. Basic Concept of RGB-RGBW Signal Conversion

In the following descriptions, the RGB signal (RGB signal to which gamma correction is not performed) obtained by the reverse gamma correction circuit 121 should be set at the RGB input signal.

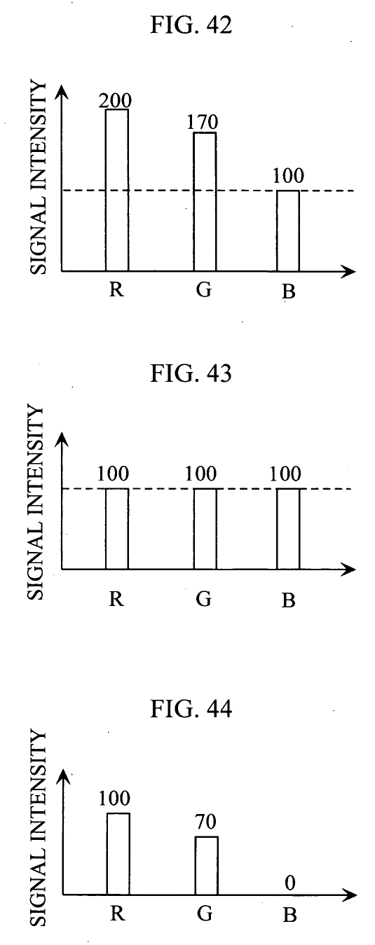

In this example, as shown in FIG. 42, it is assumed that the RGB input signal value is expressed in terms of eight bits, the R input signal value is 200, the G input signal value is 170, and the B input signal value is 100. Because the minimum value of the RGB input signal values is 100, the RGB input signal values are divided into the minimum values (min(RGB) shown in FIG. 43 and the remaining values (input signal−min(RGB)) shown in FIG. 44. In FIG. 43, the RGB input signal values are equivalent to the value of the target white Wₜ(100) when all the RGB input signal values are 100.

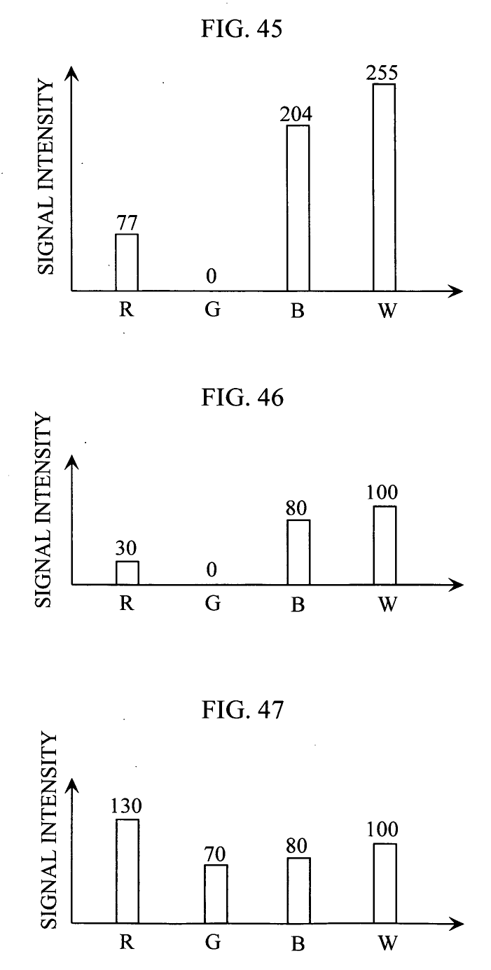

In order to express the target white Wₜ(255) when all the RGB input signal values are 255, assuming that the RGBW signal values is the signal value (77, 0, 204, 255) shown in FIG. 45, the RGBW signal value for realizing the target white Wₜ(100) becomes the RGBW signal values shown in FIG. 46 when all the RGB input signal values are 100. The signal value shown in FIG. 45 is determined by step S86 of FIG. 37.

R, G, B, and W of FIG. 46 are obtained by the following equation (20).
R=77×100/255=30
G=0×100/255=0
B=204×100/255=80
W=255×100/255=100 (20)

The RGB values of FIG. 43 are substituted for the RGBW value of FIG. 46. Therefore, the RGB value shown in FIG. 42 is converted into the RGBW value shown in FIG. 47 by adding the RGB value of FIG. 44 and the RGBW value of FIG. 46.

R, G, B, and W of FIG. 47 are obtained by the following equation (21).
R=100+30=130
G=70+0=70
B=0+80=80
W=0+100=100 (21)
4-2. RGB-RGBW Signal Converting Process

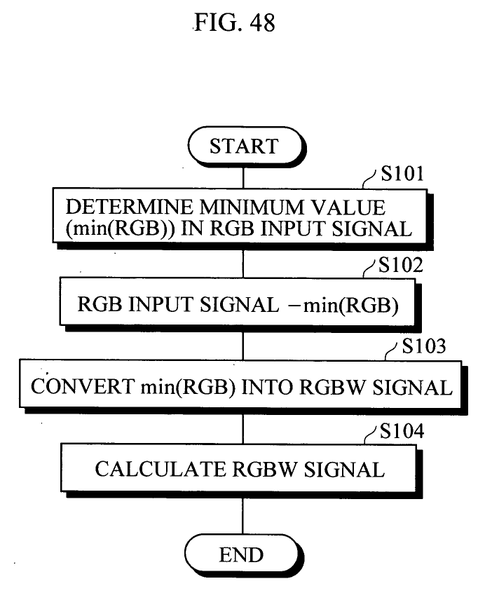

FIG. 48 shows the signal converting process for converting the RGB input signal into the RGBW signal.

First, the minimum value min(RGB) is determined in the RGB input signals (step S101). In the case where the RGB input signal has the signal values shown in FIG. 42, the minimum value min(RGB) is 100.

The minimum value min(RGB) is subtracted from each RGB input signal (step S102). In the example of FIG. 42, the subtraction results to RGB become 100, 70, and 0 as shown in FIG. 44 respectively.

Then, the minimum value min(RGB) is converted into the RGBW signal using the RGBW signal value for expressing the target white Wₜ(255) when all the RGB input signal values are 255 (step S103). When the RGBW signal value for realizing the target white Wₜ(255) has the signal values shown in FIG. 45, in the example of FIG. 42, the RGBW signal value corresponding to the minimum value min(RGB) becomes the signal values shown in FIG. 46.

Then, the RGBW signal corresponding to the RGB input signal is calculated by adding the RGBW signal value determined in step S103 to the subtraction value {RGB−min(RGB)} calculated in step S102 (step S104). In the example of FIG. 42, the RGBW signal value corresponding to the RGB input signal has the values shown in FIG. 47.

In the RGBW signal obtained by the RGB-RGBW signal conversion means 131, the RGB signal is transmitted to the RGB-RGBYe signal conversion means 132. In the RGBW signal obtained by the RGB-RGBW signal conversion means 131, the W signal becomes the W output signal of the RGB-RGBWYe signal conversion circuit 122.

5. RGB-RGBYe Signal Conversion Means 132

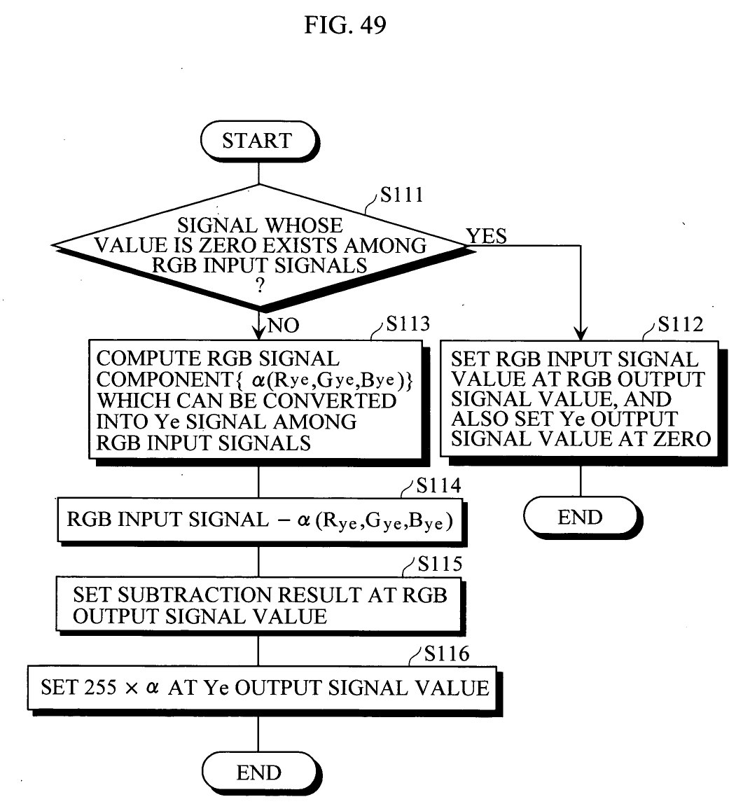

FIG. 49 shows the RGB-RGBYe signal converting process performed by the RGB-RGBYe signal conversion means 132.

In the following descriptions, the RGB signal inputted to the RGB-RGBYe signal conversion means 132 should be set at the RGB input signal.

It is determined whether the signal value having zero exists or not in the RGB input signal (step S111). If the signal value having zero exists in the RGB input signal, the Ye output signal value is caused to be set at zero while the RGB input signal value is set at the RGB output signal value (step S112).

If the signal value having zero does not exist in the RGB input signal, the RGB signal component is calculated such that at least one of the RGB subtraction results becomes zero when the RGB signal component is subtracted from the RGB input signal (step 113). The RGB signal component can be converted into the Ye signal from the RGB input signal.

Assuming that the RGB signal values for realizing the chromaticity and the maximum brightness of Ye are R_{ye}, G_{ye}, and B_{ye}, the RGB signal components converted into the Ye signal are expressed by α(R_{ye}, G_{ye}, B_{ye}). The RGB signal value for realizing the chromaticity and the maximum brightness of Ye is already determined in step S93 of FIG. 39. Therefore, first, α(R_{ye}, G_{ye}, B_{ye}) is obtained so that at least one of the RGB subtraction results becomes zero when α is subtracted from the RGB input signal. Specifically, R/R_{ye}, G/G_{ye}, and B/B_{ye} are calculated. R/R_{ye}, G/G_{ye}, and B/B_{ye} are the RGB input signal expressed in terms of R, G, and B. The minimum value of R/R_{ye}, G/G_{ye}, and B/B_{ye} is set at α, and then α(R_{ye}, G_{ye}, B_{ye}) is calculated.

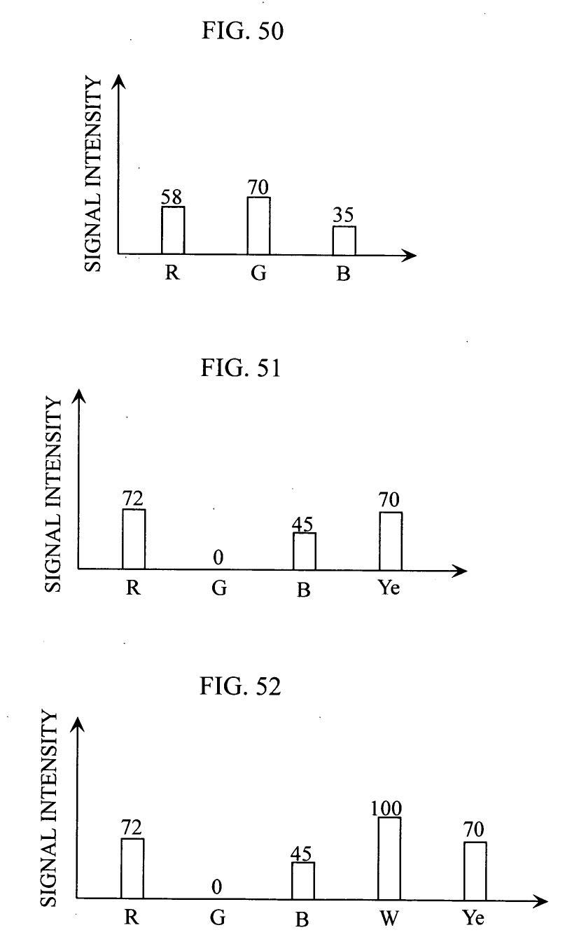

For example, it is assumed that the RGBW signal obtained by the RGB-RGBW signal conversion means 131 has the signals shown in FIG. 47. In this case, R is 130, G is 70, and B is 80 in the RGB input signal. When the RGB maximum signal value (R_{ye}, G_{ye}, B_{ye}) for realizing the chromaticity and the maximum brightness of Ye is set at R_{ye}=213, G_{ye}=255, and B_{ye}=128 respectively, R is 130, G is 70, and B is 80 in the RGB input signal. Therefore, R/R_{ye}=130/213=0.61, G/G_{ye}=70/255=0.27, and B/B_{ye}=80/128=0.63. Consequently, the minimum value becomes 0.27. Letting α=0.27 leads to αR_{ye}=58, αG_{ye}=70, and αB_{ye}=35. Namely, the RGB signal component α(R_{ye}, G_{ye}, B_{ye}) converted into the Ye signal is obtained as shown in FIG. 50.

Then, the RGB signal component α(R_{ye}, G_{ye}, B_{ye}) converted into the Ye signal is subtracted from the RGB input signal (step S114).

In the above example, the R subtraction result becomes 72 (=130−58), the G subtraction result becomes 0 (=70−70), and the B subtraction result becomes 45 (=80−35).

Each of the RGB subtraction results calculated in step S114 is set at the RGB output signal (step S115).

255×α is also set at the Ye output signal (step S116). In the above example, the Ye signal becomes 70 (=0.27×255). Namely, in the above example, the RGBYe output signal has the values shown in FIG. 51. Therefore, the final RGBWYe output signal has the values shown in FIG. 52.

1. A signal processing circuit for a self-luminous type display in which one pixel includes four unit pixels of RGBW, the signal processing circuit comprising:
first means for subtracting a minimum value in RGB input signals from each input signal of RGB;
second means for calculating an RGBW signal corresponding to the case in which all the RGB input signals are the minimum value, based on an RGBW signal value for realizing target white when all the RGB input signals are a maximum value; and
third means for determining the RGBW signal by adding a signal corresponding to each RGB subtraction result to the RGBW signal calculated by the second means, each RGB subtraction result being calculated by the first means.

2. A signal processing circuit for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness is set such that the target white can be realized by only RGB when all the RGB input signals are the same value, the signal processing circuit comprising:
first means for subtracting a minimum value in RGB input signals from each input signal of RGB;
second means for calculating an RGBW signal corresponding to the case in which all the RGB input signals are the minimum value, based on an RGBW signal value for realizing target white when all the RGB input signals are a maximum value; and
third means for determining the RGBW signal by adding a signal corresponding to each RGB subtraction result to the RGBW signal calculated by the second means, each RGB subtraction result being calculated by the first means.

3. A signal processing circuit for a self-luminous type display, in which one pixel includes four unit pixels of RGBW, color filters are provided in the RGB unit pixels respectively, and the color filter is not provided in the W unit pixel, the signal processing circuit comprising:
reverse gamma correction means for converting an RGB input signal into a pre-gamma correction RGB signal by performing reverse gamma correction to the RGB input signal, gamma correction being previously performed to the RGB input signal;
RGB-RGBW signal conversion means for setting the RGB signal at the RGB input signal to convert the RGB input signal into an RGBW signal, the RGB signal being obtained by the reverse gamma correction means; and
gamma correction means for performing the gamma correction to the RGBW signal according to the self-luminous type display, the RGBW signal being obtained by the RGB-RGBW signal conversion means, wherein
an RGBW signal value for realizing target white is set when all the RGB signals obtained by the reverse gamma correction means are a maximum value, while white-side reference brightness of RGB is set such that the target white can be realized by only RGB when all the RGB input signals obtained by the reverse gamma correction means are the same value, and
the RGB-RGBW signal conversion means includes:
first means for subtracting a minimum value in RGB input signals from each input signal of RGB;
second means for calculating an RGBW signal corresponding to the case in which all the RGB input signals are the minimum value, based on an RGBW signal value for realizing target white when all the RGB input signals are a maximum value; and
third means for determining the RGBW signal by adding a signal corresponding to each RGB subtraction result to the RGBW signal calculated by the second means, each RGB subtraction result being calculated by the first means.

4. A signal processing circuit for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing circuit comprising:
first means for subtracting a minimum value in RGB input signals from each input signal of RGB;
second means for calculating an RGBW signal corresponding to the case in which all the RGB input signals are the minimum value, based on an RGBW signal value for realizing target white when all the RGB input signals are a maximum value;
third means for determining the RGBW signal by adding a signal corresponding to each RGB subtraction result to the RGBW signal calculated by the second means, each RGB subtraction result being calculated by the first means;
fourth means for calculating the RGBW signal in the same manner as for the first means, the second means and the third means by setting the RGBW signal at an intermediate RGBW signal to regard the RGB signal in the intermediate RGBW signal as the RGB input signal, the RGBW signal being obtained by the third means, the fourth means generating the RGBW signal by adding the W signal in the intermediate RGBW signal to the W signal of the calculated RGBW signal, when the minimum value in the RGB signal in the RGBW signal calculated by the third means is not zero; and
fifth means for performing the same process as for the fourth means by setting the RGBW signal at the intermediate RGBW signal, the RGBW signal being obtained by the fourth means, when the minimum value in the RGB signal in the RGBW signal calculated by the fourth means is not zero.

5. A signal processing circuit for a self-luminous type display, in which one pixel includes four unit pixels of RGBW, color filters are provided in the RGB unit pixels respectively, and the color filter is not provided in the W unit pixel, the signal processing circuit comprising:
reverse gamma correction means for converting an RGB input signal into a pre-gamma correction RGB signal by performing reverse gamma correction to the RGB input signal, gamma correction being previously performed to the RGB input signal;
RGB-RGBW signal conversion means for setting the RGB signal at the RGB input signal to convert the RGB input signal into an RGBW signal, the RGB signal being obtained by the reverse gamma correction means; and
gamma correction means for performing the gamma correction to the RGBW signal according to the self-luminous type display, the RGBW signal being obtained by the RGB-RGBW signal conversion means, wherein an RGBW signal value for realizing target white is set when all the RGB input signals obtained by the reverse gamma correction means are a maximum value, while white-side reference brightness of RGB is set such that the target white can be realized by only RGB when all the RGB signals obtained by the reverse gamma correction means are the same value, and
the RGB-RGBW signal conversion means includes:
first means for subtracting a minimum value in RGB input signals from each input signal of RGB;
second means for calculating an RGBW signal corresponding to the case in which all the RGB input signals are the minimum value, based on an RGBW signal value for realizing target white when all the RGB input signals are a maximum value;
third means for determining the RGBW signal by adding a signal corresponding to each RGB subtraction result to the RGBW signal calculated by the second means, each RGB subtraction result being calculated by the first means;
fourth means for calculating the RGBW signal in the same manner as for the first means, the second means and the third means by setting the RGBW signal at an intermediate RGBW signal to regard the RGB signal in the intermediate RGBW signal as the RGB input signal, the RGBW signal being obtained by the third means, the fourth means generating the RGBW signal by adding the W signal in the intermediate RGBW signal to the W signal of the calculated RGBW signal, when the minimum value in the RGB signal in the RGBW signal calculated by the third means is not zero; and
fifth means for performing the same process as for the fourth means by setting the RGBW signal at the intermediate RGBW signal, the RGBW signal being obtained by the fourth means, when the minimum value in the RGB signal in the RGBW signal calculated by the fourth means is not zero.

6. A signal processing circuit for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing circuit comprising:
first means for calculating a ratio of each signal value of RGB to the W signal value as each RGB feedback ratio, based on an RGBW signal value for realizing the target white when all the RGB input signals are the maximum value;
second means for calculating the sum of an infinite geometric series in each RGB, the RGB input signal being set at a first term, each RGB feedback ratio being set at a common ratio;
third means for subtracting a minimum value in the sum of the infinite geometric series from each input signal of RGB, the sum of the infinite geometric series being calculated in each RGB by the second means;
fourth means for calculating the RGBW signal corresponding to the case in which all the RGB input signals are the minimum value, based on the RGBW signal value for realizing the target white when all the RGB input signals are the maximum value; and
fifth means for determining the RGBW signal by adding a signal corresponding to each RGB subtraction result to the RGBW signal calculated by the fourth means, each RGB subtraction result being calculated by the third means.

7. A signal processing circuit for a self-luminous type display, in which one pixel includes four unit pixels of RGBW, color filters are provided in the RGB unit pixels respectively, and the color filter is not provided in the W unit pixel, the signal processing circuit comprising:
reverse gamma correction means for converting an RGB input signal into a pre-gamma correction RGB signal by performing reverse gamma correction to the RGB input signal, gamma correction being previously performed to the RGB input signal;
RGB-RGBW signal conversion means for setting the RGB signal at the RGB input signal to convert the RGB input signal into an RGBW signal, the RGB signal being obtained by the reverse gamma correction means; and
gamma correction means for performing the gamma correction to the RGBW signal according to the self-luminous type display, the RGBW signal being obtained by the RGB-RGBW signal conversion means, wherein an RGBW signal value for realizing target white is set when all the RGB signals obtained by the reverse gamma correction means are a maximum value, while white-side reference brightness of RGB is set such that the target white can be realized by only RGB when all the RGB input signals obtained by the reverse gamma correction means are the same value, and
the RGB-RGBW signal conversion means includes:
first means for calculating a ratio of each signal value of RGB to the W signal value as each RGB feedback ratio, based on an RGBW signal value for realizing the target white when all the RGB input signals are the maximum value;
second means for calculating the sum of an infinite geometric series in each RGB, the RGB input signal being set at a first term, each RGB feedback ratio being set at a common ratio;
third means for subtracting a minimum value in the sum of the infinite geometric series from each input signal of RGB, the sum of the infinite geometric series being calculated in each RGB by the second means;
fourth means for calculating the RGBW signal corresponding to the case in which all the RGB input signals are the minimum value, based on the RGBW signal value for realizing the target white when all the RGB input signals are the maximum value; and
fifth means for determining the RGBW signal by adding a signal corresponding to each RGB subtraction result to the RGBW signal calculated by the fourth means, each RGB subtraction result being calculated by the third means.

8. A signal processing method for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing method comprising:
a first step of subtracting a minimum value in RGB input signals from each input signal of RGB;
a second step of calculating an RGBW signal corresponding to the case in which all the RGB input signals are the minimum value, based on an RGBW signal value for realizing target white when all the RGB input signals are a maximum value; and
a third step of determining the RGBW signal by adding a signal corresponding to each RGB subtraction result to the RGBW signal calculated in the second step, each RGB subtraction result being calculated in the first step.

9. A signal processing method for a self-luminous type display, in which one pixel includes four unit pixels of RGBW, color filters are provided in the RGB unit pixels respectively, and the color filter is not provided in the W unit pixel, the signal processing method comprising:
a reverse gamma correction step of converting an RGB input signal into a pre-gamma correction RGB signal by performing reverse gamma correction to the RGB input signal, gamma correction being previously performed to the RGB input signal;
an RGB-RGBW signal conversion step of setting the RGB signal at the RGB input signal to convert the RGB input signal into an RGBW signal, the RGB signal being obtained in the reverse gamma correction step; and
a gamma correction step of performing the gamma correction to the RGBW signal according to the self-luminous type display, the RGBW signal being obtained in the RGB-RGBW signal conversion step, wherein
an RGBW signal value for realizing target white is set when all the RGB input signals obtained in the reverse gamma correction step are a maximum value, while white-side reference brightness of RGB is set such that the target white can be realized by only RGB when all the RGB input signals obtained in the reverse gamma correction step are the same value, and
the RGB-RGBW signal conversion step includes:
a first step of subtracting a minimum value in RGB input signals from each input signal of RGB;
a second step of calculating an RGBW signal corresponding to the case in which all the RGB input signals are the minimum value, based on an RGBW signal value for realizing target white when all the RGB input signals are a maximum value; and
a third step of determining the RGBW signal by adding a signal corresponding to each RGB subtraction result to the RGBW signal calculated in the second step, each RGB subtraction result being calculated in the first step.

10. A signal processing method for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing method comprising:
a first step of subtracting a minimum value in RGB input signals from each input signal of RGB;
a second step of calculating an RGBW signal corresponding to the case in which all the RGB input signals are the minimum value, based on an RGBW signal value for realizing target white when all the RGB input signals are a maximum value;
a third step of determining the RGBW signal by adding a signal corresponding to each RGB subtraction result to the RGBW signal calculated in the second step, each RGB subtraction result being calculated in the first step;
a fourth step of calculating the RGBW signal in the same manner as for the first step, the second step and the third step by setting the RGBW signal at an intermediate RGBW signal to regard the RGB signal in the intermediate RGBW signal as the RGB input signal, the RGBW signal being obtained in the third step, the fourth step generating the RGBW signal by adding the W signal in the intermediate RGBW signal to the W signal of the calculated RGBW signal, when the minimum value in the RGB signal in the RGBW signal calculated in the third step is not zero; and
a fifth step of performing the same process as for the fourth step by setting the RGBW signal at the intermediate RGBW signal, the RGBW signal being obtained in the fourth step, when the minimum value in the RGB signal in the RGBW signal calculated in the fourth step is not zero.

11. A signal processing method for a self-luminous type display, in which one pixel includes four unit pixels of RGBW, color filters are provided in the RGB unit pixels respectively, and the color filter is not provided in the W unit pixel, the signal processing method comprising:
a reverse gamma correction step of converting an RGB input signal into a pre-gamma correction RGB signal by performing reverse gamma-correction to the RGB input signal, gamma correction being previously performed to the RGB input signal;
an RGB-RGBW signal conversion step of setting the RGB signal at the RGB input signal to convert the RGB input signal into an RGBW signal, the RGB signal being obtained in the reverse gamma correction step; and
a gamma correction step of performing the gamma correction to the RGBW signal according to the self-luminous type display, the RGBW signal being obtained in the RGB-RGBW signal conversion step, wherein
an RGBW signal value for realizing target white is set when all the RGB signals obtained in the reverse gamma correction step are a maximum value, while white-side reference brightness of RGB is set such that the target white can be realized by only RGB when all the RGB input signals obtained in the reverse gamma correction step are the same value, and
the RGB-RGBW signal conversion step includes:
a first step of subtracting a minimum value in RGB input signals from each input signal of RGB;
a second step of calculating an RGBW signal corresponding to the case in which all the RGB input signals are the minimum value, based on an RGBW signal value for realizing target white when all the RGB input signals are a maximum value;
a third step of determining the RGBW signal by adding a signal corresponding to each RGB subtraction result to the RGBW signal calculated in the second step, each RGB subtraction result being calculated in the first step;
a fourth step of calculating the RGBW signal in the same manner as for the first step, the second step and the third step by setting the RGBW signal at an intermediate RGBW signal to regard the RGB signal in the intermediate RGBW signal as the RGB input signal, the RGBW signal being obtained in the third step, the fourth step generating the RGBW signal by adding the W signal in the intermediate RGBW signal to the W signal of the calculated RGBW signal, when the minimum value in the RGB signal in the RGBW signal calculated in the third step is not zero; and
a fifth step of performing the same process as for the fourth step by setting the RGBW signal at the intermediate RGBW signal, the RGBW signal being obtained in the fourth step, when the minimum value in the RGB signal in the RGBW signal calculated in the fourth step is not zero.

12. A signal processing method for a self-luminous type display, in which one pixel includes four unit pixels of RGBW, color filters are provided in the RGB unit pixels respectively, the color filter is not provided in the W unit pixel, and an RGBW signal value for realizing target white is set when all the RGB input signals are a maximum value, while white-side reference brightness of RGB is set such that the target white can be realized by only RGB when all the RGB input signals are the same value, the signal processing method comprising:
a first step of calculating a ratio of each signal value of RGB to the W signal value as each RGB feedback ratio, based on an RGBW signal value for realizing the target white when all the RGB input signals are the maximum value;
a second step of calculating the sum of an infinite geometric series in each RGB, the RGB input signal being set at a first term, each RGB feedback ratio being set at a common ratio;
a third step of subtracting a minimum value in the sum of the infinite geometric series from each input signal of RGB, the sum of the infinite geometric series being calculated in each RGB in the second step;
a fourth step of calculating the RGBW signal corresponding to the case in which all the RGB input signals are the minimum value, based on the RGBW signal value for realizing the target white when all the RGB input signals are the maximum value; and
a fifth step of determining the RGBW signal by adding a signal corresponding to each RGB subtraction result to the RGBW signal calculated in the fourth step, each RGB subtraction result being calculated in the third step.

13. A signal processing method for a self-luminous type display, in which one pixel includes four unit pixels of RGBW, color filters are provided in the RGB unit pixels respectively, and the color filter is not provided in the W unit pixel, the signal processing method comprising:
a reverse gamma correction step of converting an RGB input signal into a pre-gamma correction RGB signal by performing reverse gamma correction to the RGB input signal, gamma correction being previously performed to the RGB input signal;
an RGB-RGBW signal conversion step of setting the RGB signal at the RGB input signal to convert the RGB input signal into an RGBW signal, the RGB signal being obtained in the reverse gamma correction step; and
a gamma correction step of performing the gamma correction to the RGBW signal according to the self-luminous type display, the RGBW signal being obtained in the RGB-RGBW signal conversion step, wherein
an RGBW signal value for realizing target white is set when all the RGB input signals obtained in the reverse gamma correction step are a maximum value, while white-side reference brightness of RGB is set such that the target white can be realized by only RGB when all the RGB signals obtained in the reverse gamma correction step are the same value, and
the RGB-RGBW signal conversion step includes:
a first step of calculating a ratio of each signal value of RGB to the W signal value as each RGB feedback ratio, based on an RGBW signal value for realizing the target white when all the RGB input signals are the maximum value;
a second step of calculating the sum of an infinite geometric series in each RGB, the RGB input signal being set at a first term, each RGB feedback ratio being set at a common ratio;
a third step of subtracting a minimum value in the sum of the infinite geometric series from each input signal of RGB, the sum of the infinite geometric series being calculated in each RGB in the second step;
a fourth step of calculating the RGBW signal corresponding to the case in which all the RGB input signals are the minimum value, based on the RGBW signal value for realizing the target white when all the RGB input signals are the maximum value; and
a fifth step of determining the RGBW signal by adding a signal corresponding to each RGB subtraction result to the RGBW signal calculated in the fourth step, each RGB subtraction result being calculated in the third step.

14. A signal processing circuit for a self-luminous type display, in which one pixel includes four unit pixels of RGBX, an arbitrary color except for RGB is set at X, and an RGB signal value for realizing chromaticity and maximum brightness of X is set by an RGB signal, the signal processing circuit comprising:
RGB-RGBX signal conversion means for converting an RGB input signal into an RGBX signal, wherein
the RGB-RGBX signal conversion means includes:
first means for calculating an RGB signal component based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal;
second means for subtracting the RGB signal component from the RGB input signal to output the subtraction result as the RGB signal, the RGB signal component being calculated by the first means; and
third means for outputting the X signal corresponding to the RGB signal component calculated by the first means.

15. A signal processing circuit for a self-luminous type display, in which one pixel includes four unit pixels of RGBX and an arbitrary color except for RGB is set at X, the signal processing circuit comprising:
reverse gamma correction means for converting an RGB input signal into a pre-gamma correction RGB signal by performing reverse gamma correction to the RGB input signal, gamma correction being previously performed to the RGB input signal;
RGB-RGBX signal conversion means for setting the RGB signal at the RGB input signal to convert the RGB input signal into an RGBX signal, the RGB signal being obtained by the reverse gamma correction means; and
gamma correction means for performing the gamma correction to the RGBX signal according to the self-luminous type display, the RGBX signal being obtained by the RGB-RGBX signal conversion means, wherein
an RGB signal value for realizing chromaticity and maximum brightness of X is set by the RGB signal with respect to the pre-gamma correction RGB signal obtained by the reverse gamma correction means, and
the RGB-RGBX signal conversion means includes:
first means for calculating an RGB signal component based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal;
second means for subtracting the RGB signal component from the RGB input signal to output the subtraction result as the RGB signal, the RGB signal component being calculated by the first means; and
third means for outputting the X signal corresponding to the RGB signal component calculated by the first means.

16. A signal processing method for a self-luminous type display, in which one pixel includes four unit pixels of RGBX, an arbitrary color except for RGB is set at X, and an RGB signal value for realizing chromaticity and maximum brightness of X is set by an RGB signal, the signal processing method comprising:
an RGB-RGBX signal conversion step of converting an RGB input signal into an RGBX signal, wherein
the RGB-RGBX signal conversion step includes:
a first step of calculating an RGB signal component based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal;
a second step of subtracting the RGB signal component from the RGB input signal to output the subtraction result as the RGB signal, the RGB signal component being calculated in the first step; and
a third step of outputting the X signal corresponding to the RGB signal component calculated in the first step.

17. A signal processing method for a self-luminous type display, in which one pixel includes four unit pixels of RGBX and an arbitrary color except for RGB is set at X, the signal processing method comprising:
a reverse gamma correction step of converting an RGB input signal into a pre-gamma correction RGB signal by performing reverse gamma correction to the RGB input signal, gamma correction being previously performed to the RGB input signal;
an RGB-RGBX signal conversion step of setting the RGB signal at the RGB input signal to convert the RGB input signal into an RGBX signal, the RGB signal being obtained in the reverse gamma correction step; and
a gamma correction step of performing the gamma correction to the RGBX signal according to the self-luminous type display, the RGBX signal being obtained in the RGB-RGBX signal conversion step, wherein
an RGB signal value for realizing chromaticity and maximum brightness of X is set by the RGB signal with respect to the pre-gamma correction RGB signal obtained in the reverse gamma correction step, and
the RGB-RGBX signal conversion step includes:
a first step of calculating an RGB signal component based on the RGB signal value for realizing chromaticity and maximum brightness of X such that at least one of RGB subtraction results becomes zero, when the RGB signal component is subtracted from the RGB input signal, the RGB signal component being able to be converted into the X signal from the RGB input signal;
a second step of subtracting the RGB signal component from the RGB input signal to output the subtraction result as the RGB signal, the RGB signal component being calculated in the first step; and
a third step of outputting the X signal corresponding to the RGB signal component calculated in the first step.

18. A signal processing circuit for a self-luminous type display, in which one pixel includes five unit pixels of RGBWX, an arbitrary color except for RGBW is set at X, color filters are provided in the RGBX unit pixels respectively, the color filter is not provided in the W unit pixel, and an RGBW signal value for realizing target white is set when all the RGB input signals are a maximum value, and an RGB signal value for realizing chromaticity and maximum brightness of X by an RGB signal is set, while white-side reference brightness of RGB is set such that the target white can be realized by only RGB when all the RGB input signals are the same value, the signal processing circuit comprising:
RGB-RGBWX signal conversion means for converting the RGB input signal into an RGBWX signal, wherein
the RGB-RGBWX signal conversion means includes:
first means for subtracting a minimum value in RGB input signals from each input signal of RGB;
second means for calculating an RGBW signal corresponding to the case in which all the RGB input signals are the minimum value, based on an RGBW signal value for realizing target white when all the RGB input signals are a maximum value;
third means for determining a first R signal, a first G signal, a first B signal, and a W signal by adding a signal corresponding to each RGB subtraction result to the RGBW signal calculated by the second means, each RGB subtraction result being calculated by the first means;
fourth means for calculating an RGB signal component based on the RGB signal value for realizing chromaticity and maximum brightness of X by the RGB signal such that at least one of RGB subtraction results becomes zero when the RGB signal component is subtracted from the first R signal, the first G signal, and the first B signal, the RGB signal component being able to be converted into an X signal from the first R signal, the first G signal, and the first B signal obtained by the third means;
fifth means for calculating a second R signal, a second G signal, and a second B signal by subtracting the RGB signal component from the first R signal, the first G signal, and the first B signal, the RGB signal component being obtained by the first means;
sixth means for calculating the X signal corresponding to the RGB signal component calculated by the fourth means; and
seventh means for outputting the W signal, the second R signal, the second G signal, the second B signal, and the X signal as the RGBWX signal corresponding to the RGB input signal, the W signal being obtained by the third means, the second R signal, the second G signal, and the second B signal being obtained by the fifth means, the X signal being obtained by the sixth means.

19. A signal processing circuit for a self-luminous type display, in which one pixel includes five unit pixels of RGBWX, an arbitrary color except for RGBW is set at X, color filters are provided in the RGBX unit pixels respectively, and the color filter is not provided in the W unit pixel, the signal processing circuit comprising:
reverse gamma correction means for converting an RGB input signal into a pre-gamma correction RGB signal by performing reverse gamma correction to the RGB input signal, gamma correction being previously performed to the RGB input signal;
RGB-RGBWX signal conversion means for setting the RGB signal at the RGB input signal to convert the RGB input signal into an RGBWX signal, the RGB signal being obtained by the reverse gamma correction means; and
gamma correction means for performing the gamma correction to the RGBWX signal according to the self-luminous type display, the RGBWX signal being obtained by the RGB-RGBWX signal conversion means, wherein an RGBW signal value for realizing target white is set when all the RGB input signals obtained by the reverse gamma correction means are a maximum value, and an RGB signal value for realizing chromaticity and maximum brightness of X by the RGB signal obtained by the reverse gamma correction means is set, while white-side reference brightness of RGB is set such that the target white can be realized by only RGB when all the RGB input signals obtained by the reverse gamma correction means are the same value, and
the RGB-RGBWX signal conversion means includes:
first means for subtracting a minimum value in RGB input signals from each input signal of RGB;
second means for calculating an RGBW signal corresponding to the case in which all the RGB input signals are the minimum value, based on an RGBW signal value for realizing target white when all the RGB input signals are a maximum value;
third means for determining a first R signal, a first G signal, a first B signal, and a W signal by adding a signal corresponding to each RGB subtraction result to the RGBW signal calculated by the second means, each RGB subtraction result being calculated by the first means;
fourth means for calculating an RGB signal component based on the RGB signal value for realizing chromaticity and maximum brightness of X by the RGB signal such that at least one of RGB subtraction results becomes zero when the RGB signal component is subtracted from the first R signal, the first G signal, and the first B signal, the RGB signal component being able to be converted into an X signal from the first R signal, the first G signal, and the first B signal obtained by the third means;
fifth means for calculating a second R signal, a second G signal, and a second B signal by subtracting the RGB signal component from the first R signal, the first G signal, and the first B signal, the RGB signal component being obtained by the first means;
sixth means for calculating the X signal corresponding to the RGB signal component calculated by the fourth means; and
seventh means for outputting the W signal, the second R signal, the second G signal, the second B signal, and the X signal as the RGBWX signal corresponding to the RGB input signal, the W signal being obtained by the third means, the second R signal, the second G signal, and the second B signal being obtained by the fifth means, the X signal being obtained by the sixth means.

20. A signal processing method for a self-luminous type display, in which one pixel includes five unit pixels of RGBWX, an arbitrary color except for RGBW is set at X, color filters are provided in the RGBX unit pixels respectively, the color filter is not provided in the W unit pixel, and an RGBW signal value for realizing target white is set when all the RGB input signals are a maximum value, and an RGB signal value for realizing chromaticity and maximum brightness of X by an RGB signal is set, while white-side reference brightness of RGB is set such that the target white can be realized by only RGB when all the RGB input signals are the same value, the signal processing method comprising:
an RGB-RGBWX signal conversion step of converting the RGB input signal into an RGBWX signal, wherein
the RGB-RGBWX signal conversion step includes:
a first step of subtracting a minimum value in RGB input signals from each input signal of RGB;
a second step of calculating an RGBW signal corresponding to the case in which all the RGB input signals are the minimum value, based on an RGBW signal value for realizing target white when all the RGB input signals are a maximum value;
a third step of determining a first R signal, a first G signal, a first B signal, and a W signal by adding a signal corresponding to each RGB subtraction result to the RGBW signal calculated in the second step, each RGB subtraction result being calculated in the first step;
a fourth step of calculating an RGB signal component based on the RGB signal value for realizing chromaticity and maximum brightness of X by the RGB signal such that at least one of RGB subtraction results becomes zero when the RGB signal component is subtracted from the first R signal, the first G signal, and the first B signal, the RGB signal component being able to be converted into an X signal from the first R signal, the first G signal, and the first B signal obtained in the third step;
a fifth step of calculating a second R signal, a second G signal, and a second B signal by subtracting the RGB signal component from the first R signal, the first G signal, and the first B signal, the RGB signal component being obtained in the first step;
a sixth step of calculating the X signal corresponding to the RGB signal component calculated in the fourth step; and
a seventh step of outputting the W signal, the second R signal, the second G signal, the second B signal, and the X signal as the RGBWX signal corresponding to the RGB input signal, the W signal being obtained in the third step, the second R signal, the second G signal, and the second B signal being obtained in the fifth step, the X signal being obtained in the sixth step.

21. A signal processing method for a self-luminous type display, in which one pixel includes five unit pixels of RGBWX, an arbitrary color except for RGBW is set at X, color filters are provided in the RGBX unit pixels respectively, and the color filter is not provided in the W unit pixel, the signal processing method comprising:
a reverse gamma correction step of converting an RGB input signal into a pre-gamma correction RGB signal by performing reverse gamma correction to the RGB input signal, gamma correction being previously performed to the RGB input signal;
an RGB-RGBWX signal conversion step of setting the RGB signal at the RGB input signal to convert the RGB input signal into an RGBWX signal, the RGB signal being obtained in the reverse gamma correction step; and
a gamma correction step of performing the gamma correction to the RGBWX signal according to the self-luminous type display, the RGBWX signal being obtained in the RGB-RGBWX signal conversion step, wherein
an RGBW signal value for realizing target white is set when all the RGB input signals obtained in the reverse gamma correction step are a maximum value, and an RGB signal value for realizing chromaticity and maximum brightness of X by the RGB signal obtained in the reverse gamma correction step is set, while white-side reference brightness of RGB is set such that the target white can be realized by only RGB when all the RGB signals obtained in the reverse gamma correction step are the same value, and
the RGB-RGBWX signal conversion step includes:
a first step of subtracting a minimum value in RGB input signals from each input signal of RGB;
a second step of calculating an RGBW signal corresponding to the case in which all the RGB input signals are the minimum value, based on an RGBW signal value for realizing target white when all the RGB input signals are a maximum value;
a third step of determining a first R signal, a first G signal, a first B signal, and a W signal by adding a signal corresponding to each RGB subtraction result to the RGBW signal calculated in the second step, each RGB subtraction result being calculated in the first step;
a fourth step of calculating an RGB signal component based on the RGB signal value for realizing chromaticity and maximum brightness of X by the RGB signal such that at least one of RGB subtraction results becomes zero when the RGB signal component is subtracted from the first R signal, the first G signal, and the first B signal, the RGB signal component being able to be converted into an X signal from the first R signal, the first G signal, and the first B signal obtained in the third step;
a fifth step of calculating a second R signal, a second G signal, and a second B signal by subtracting the RGB signal component from the first R signal, the first G signal, and the first B signal, the RGB signal component being obtained in the first step;
a sixth step of calculating the X signal corresponding to the RGB signal component calculated in the fourth step; and
a seventh step of outputting the W signal, the second R signal, the second G signal, the second B signal, and the X signal as the RGBWX signal corresponding to the RGB input signal, the W signal being obtained in the third step, the second R signal, the second G signal, and the second B signal being obtained in the fifth step, the X signal being obtained in the sixth step.
